(19) United States
(12) Patent Application Publication
(10) Pub. No.: US 2014/0034671 A1
(43) Pub. Date: Feb. 6, 2014

(54) GENERALLY CYLINDRICALLY-SHAPED LINER FOR USE IN PRESSURE DISPENSE SYSTEMS AND METHODS OF MANUFACTURING THE SAME

(71) Applicants: Richard Chism, Round Rock, TX (US); Amy Koland, Eden Prairie, MN (US); Wei Liu, Eden Prairie, MN (US); John Davis, Tokyo (JP); Glenn Tom, Bloomington, MN (US); Matt Kusz, Lincoln, NE (US); Karl Boggs, Hopewell Junction, NY (US)

(72) Inventors: Richard Chism, Round Rock, TX (US); Amy Koland, Eden Prairie, MN (US); Wei Liu, Eden Prairie, MN (US); John Davis, Tokyo (JP); Glenn Tom, Bloomington, MN (US); Matt Kusz, Lincoln, NE (US); Karl Boggs, Hopewell Junction, NY (US)

(73) Assignee: ADVANCED TECHNOLOGY MATERIALS, INC, Danbury, CT (US)

(21) Appl. No.: 13/991,641

(22) PCT Filed: Dec. 9, 2011
(86) PCT No.: PCT/US11/64141

§ 371 Date: Oct. 18, 2013

Related U.S. Application Data
(60) Provisional application No. 61/432,889, filed on Jan. 14, 2011.
(60) Provisional application No. 61/556,943, filed on Nov. 8, 2011.
(60) Provisional application No. 61/422,030, filed on Dec. 10, 2010.
(60) Provisional application No. 61/424,167, filed on Dec. 17, 2010.
(60) Provisional application No. 61/501,925, filed on Jun. 28, 2011.

(51) Int. Cl. B65D 35/28; B67D 1/00; B65D 35/56

(52) U.S. Cl. CPC B65D 25/14; B67D 1/0001
USPC 222/95; 383/105; 383/107; 220/495.01; 222/105

(57) ABSTRACT

A liner having a tubular body portion with a top circumferential edge and a bottom circumferential edge, a generally circular bottom portion sealed to the tubular body portion along the bottom circumferential edge, and a generally circular top portion sealed to the tubular body portion along the top circumferential edge. The top portion may include a fitment sealed thereto. The tubular body portion may include at least one weld seam extending from the top circumferential edge to the bottom circumferential edge. In a particular embodiment, the tubular body portion may include two sheets welded together to form a tubular body, the tubular body portion thus having two weld seams extending from the top circumferential edge to the bottom circumferential edge.

### FIELD OF THE INVENTION

The present disclosure relates to liner-based storage and dispensing systems. More particularly, the present disclosure relates to liners for use with generally cylindrically-shaped overpacks, whereby the liner is configured to substantially conform to the size and shape of the interior of the overpack. More particularly, the present disclosure relates to a liner comprising a tubular body portion; a bottom portion sealed to one end of the tubular body portion; and a top portion sealed to the other end of the tubular body portion, where the top portion also includes a fitment. Further, the contents of the liner of the present disclosure may be dispensed by pressure dispense with or without the use of a dip tube and/or a choke-off preventer.

### BACKGROUND OF THE INVENTION

Numerous manufacturing processes require the use of ultrapure liquids, such as acids, solvents, bases, photoresists, slurries, cleaning formulations, dopants, inorganic, organic, metalorganic and biological solutions, pharmaceuticals, and radioactive chemicals. Such applications require that the number and size of particles in the ultrapure liquids be minimized. In particular, because ultrapure liquids are used in many aspects of the microelectronic manufacturing process, semiconductor manufacturers have established strict particle concentration specifications for process chemicals and chemical-handling equipment. Such specifications are needed because, should the liquids used during the manufacturing process contain high levels of particles or bubbles, the particles or bubbles may be deposited on solid surfaces of the silicon. This can, in turn, lead to product failure and reduced quality and reliability.

Accordingly, storage, transportation, and dispensing of such ultrapure liquids require containers capable of providing adequate protection for the retained liquids. Collapsible liner-based containers, such as the. NOWPak® dispense system marketed by ATMI, Inc., are capable of reducing such air-liquid interfaces by pressurizing, with gas or fluid, onto the liner, as opposed to directly onto the liquid in the container, while dispensing. However, pressure dispense is not traditionally used with certain liner-based systems. For example, liner-based systems that include drum or canister style overpacks often dispense the contents of the liner via pump dispense. Pump dispense systems can be disadvantageous because they can be very expensive and may easily break down.

Additionally, for a variety of reasons associated with these types of liner-based systems, the liners are traditionally open-ended, drum-shaped liners or are closed liners that are not configured to conform to the shape of the overpack. Such liners may be unable to provide adequate protection against environmental conditions. For example, the contents of open-ended liners are exposed to the environment and can be contaminated easily. Additionally, such traditional liners may fail to protect the retained liquid against pinhole punctures and tears in the welds sometimes caused by elastic deformation of the liners from vibrations, such as those brought on by transportation of the container. The vibrations from transportation can elastically deform or flex a liner many times (e.g., thousands to millions of times) between the source and final destinations. The greater the vibration, the more probable that pinholes and weld tears will be produced. Other causes of pinholes and weld tears include shock effect, drops, or large amplitude movements of the container. In pressure dispense applications, gas may be undesirably introduced through the pinholes or weld tears, thereby contaminating the retained liquids over time, as the gas will be permitted to go into the solution and undesirably come out into the manufacturing process, e.g., onto the wafer as bubbles.

Additionally, traditional closed, collapsible liners are configured to be filled with a specified amount of liquid. However, the liners do not fit neatly within their respective outer containers because folds are created in the liners as they are inflated inside the containers. The folds may preclude liquid from filling the liners in the space taken up by the folds. Accordingly, when the container is filled with the specified amount of liquid, the liquid tends to overflow the container resulting in loss of liquid. As stated previously, such liquids are typically ultrapure liquids, such as acids, solvents, bases, photoresists, dopants, inorganic, organic, and biological solutions, pharmaceuticals, and radioactive chemicals, which can be very expensive, for example about $2,500/L or more. Thus, even a small amount of overflow is undesirable.

Further yet, packaging or container systems for transporting certain types of materials are required to meet specific UN DOT certifications. For example, to be certified as a non-removable head container for transporting certain hazardous materials, the container opening cannot exceed 3 inches in diameter. Accordingly, in many cases, it would be desirable to have a collapsible liner designed to overcome the disadvantages described above while also being capable of fitting within container openings for containers meeting UN DOT certifications for hazardous materials.

Thus, there exists a need in the art for better liner systems for ultrapure liquids that do not include the disadvantages presented by prior liners for use in generally cylindrically-shaped overpacks. There is a need in the art for a generally cylindrically-shaped liner-based storage and dispensing system that addresses the problems associated with pinholes, weld tears, gas pressure saturation, and overflow, and can be fit or substantially easily fit within standard openings of UN DOT certified containers. There is a need in the art for generally cylindrically-shaped liner-based storage and dispensing systems that addresses the problems associated with excess folds in the liner that can result in additional trapped gas within the liner. There is also a need in the art for liners that are configured such that choke-off is limited or eliminated.

### BRIEF SUMMARY OF THE INVENTION

The present disclosure, in one embodiment, relates to a liner having a tubular body portion with a top circumferential edge and a bottom circumferential edge, a generally circular bottom portion sealed to the tubular body portion along the bottom circumferential edge, and a generally circular top portion sealed to the tubular body portion along the top circumferential edge. The top portion may include a fitment sealed thereto. The tubular body portion may include at least one weld seam extending from the top circumferential edge to the bottom circumferential edge. In a particular embodiment, the tubular body portion may include two sheets welded together to form a tubular body, the tubular body portion thus having two weld seams extending from the top circumferential edge to the bottom circumferential edge. The liner can be configured to be positioned within a non-removable head container having no larger than a three inch opening by inserting the liner in a collapsed state into the container through the opening, with the fitment positioned inside the opening. Each of the liner portions may have a liner wall with multiple layers. Similarly, each of the liner portions may have a liner wall with a thickness from 80 microns to 280 microns. The liner may further include means for reducing the occurrence of a choke point.

The present disclosure, in another embodiment, relates to a liner-based system having an overpack, the overpack including a generally cylindrically-shaped interior and an opening on at least one end, and also including a flexible liner positioned therein, the liner having a tubular body portion having a top circumferential edge and a bottom circumferential edge, a generally circular bottom portion sealed to the tubular body portion along the bottom circumferential edge, and a generally circular top portion sealed to the tubular body portion along the top circumferential edge. The top portion may also include a fitment sealed thereto. In some embodiments, the overpack may be a non-removable head container having no larger than a three inch opening. The liner, in an expanded state, may substantially conform to the generally cylindrically-shaped interior of the overpack. The tubular body portion of the liner may include at least one weld seam extending from the top circumferential edge to the bottom circumferential edge, and in a particular embodiment, the tubular body portion of the liner may include two sheets welded together to form a tubular body, the tubular body portion thus having two weld seams extending from the top circumferential edge to the bottom circumferential edge. Each of the liner portions may have a liner wall with multiple layers. Similarly, each of the liner portions may have a liner wall with a thickness from 80 microns to 280 microns. In some embodiments, the overpack may additionally include a fluid inlet in communication with an annular space between the overpack and the liner, permitting a gas or fluid to be introduced into the annular space, causing collapse of the liner and dispense of contents therein through the fitment.

The present disclosure, in yet another embodiment, relates to a method for dispensing contents from a liner-based system. The method can include coupling a pressure source to a fluid inlet of an overpack, where the overpack includes a generally cylindrically-shaped interior and an opening on at least one end, and also includes a flexible liner positioned therein, the liner having a tubular body portion having a top circumferential edge and a bottom circumferential edge, a generally circular bottom portion sealed to the tubular body portion along the bottom circumferential edge, and a generally circular top portion sealed to the tubular body portion along the top circumferential edge and including a fitment sealed thereto. The fluid inlet is in communication with an annular space between the overpack and the liner. The method for dispensing contents further includes dispensing contents of the liner by introducing a gas or fluid from the pressure source into the annular space via the fluid inlet, thereby collapsing the liner and causing dispense of contents therein through the fitment. The method may also include connecting a dispense connector to the fitment of the liner for receiving the dispensed contents, the dispense connector having a probe with a tube extending only a relatively short distance into an interior of the liner through the fitment. The method may also include removing headspace gas prior to dispensing contents of the liner. In some embodiments, the method may further involve monitoring a dispense pressure to determine when the liner nears empty.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present invention. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the various embodiments of the present disclosure, it is believed that the invention will be better understood from the following description taken in conjunction with the accompanying Figures, in which:

FIG. 1 is a cross-sectional view of a liner-based system in accordance with an embodiment of the present disclosure.

FIG. 2A is a perspective view of a liner for use in a liner-based system in accordance with an embodiment of the present disclosure.

FIG. 2B is a perspective view of a liner for use in a liner-based system in accordance with an embodiment of the present disclosure.

FIG. 2C shows components of a liner in accordance with one embodiment of the present disclosure.

FIG. 2D shows components of a liner in accordance with another embodiment of the present disclosure.

FIG. 2E shows a perspective view of a liner for use in a liner-based system in accordance with an embodiment of the present disclosure.

FIG. 2F shows a perspective view of a liner for use in a liner-based system in accordance with another embodiment of the present disclosure.

FIG. 2G shows a cross-sectional cut-away view of a circumferential top seam in accordance with one embodiment of the present disclosure.

FIG. 2H shows a cross-sectional cut-away view of a circumferential top seam in accordance with another embodiment of the present disclosure.

FIG. 3 is a cross-sectional view of a multi-layer liner according to one embodiment of the present disclosure.

FIG. 4A shows a machine for manufacturing liners for liner-based systems in accordance with an embodiment of the present disclosure.

FIG. 4B shows a perspective view of a liner for use in a liner-based system in accordance with an embodiment of the present disclosure.

FIG. 4C shows a cross-sectional view of a liner-based system in accordance with an embodiment of the present disclosure.

FIG. 5A is a cross-sectional view and of a liner-based system configured for pressure dispense in accordance with one embodiment of the present disclosure.

FIG. 5B is a graph showing inlet gas pressure increasing as the liner nears complete dispense in accordance with one embodiment of the present disclosure.

FIG. 6 shows a perspective view of a chock off preventer for use with some embodiments of liners of the present disclosure.

FIG. 7 shows a perspective view of a closure and/or connecting assembly for use in accordance with some embodiments of the present disclosure.

FIG. 8 is a perspective view of an apparatus that may be used to prevent choke-off according to one embodiment of the present disclosure.

FIG. 9 is a perspective view of an apparatus that may be used to prevent choke-off according to another embodiment of the present disclosure.

FIG. 10 is a perspective view of an apparatus that may be used to prevent choke-off according to yet another embodiment of the present disclosure.

FIG. 11 is a cross-sectional view of a contractible layer that may be added to a liner to prevent choke-off according to one embodiment of the present disclosure.

FIG. 12 is a perspective view of an insert that may be used to prevent choke-off according to one embodiment of the present disclosure.

FIG. 13 is a perspective view of an insert that may be used to prevent choke-off according to another embodiment of the present disclosure.

FIG. 14 is a perspective view of an insert that may be used to prevent choke-off according to yet another embodiment of the present disclosure.

FIG. 15 is an end perspective view of a liner that may be used to prevent choke-off according to one embodiment of the present disclosure.

FIG. 16 shows an interior surface of a liner with surface features according to one embodiment of the present disclosure.

FIG. 17 shows an interior surface of a liner with surface features according to another embodiment of the present disclosure.

FIG. 18 shows an interior surface of a liner with surface features according to yet another embodiment of the present disclosure.

FIG. 19A shows a modified fitment in a closed position in accordance with one embodiment of the present disclosure.

FIG. 19B shows a modified fitment in an open position in accordance with the present disclosure.

FIGS. 20A-32 show embodiments for reducing or preventing choke-off in accordance with the present disclosure.

FIG. 33A shows a traditional 2 dimensional pillow type liner that is filled and disposed in an overpack.

FIG. 33B shows a filled liner of the present disclosure disposed inside of an overpack in accordance with one embodiment of the present disclosure.

FIG. 34 is perspective view of a coupler constituting part of a snap-together diptube assembly according to one embodiment of the present disclosure.

FIG. 35 is a perspective view of tubing having holes therein for snap-engagement with the snap-in-place protrusions of the coupler.

FIG. 36 is an elevation, cross-sectional view of the coupler and tubing of FIGS. 34 and 35 as engaged with one another.

FIG. 37 is a perspective view of a coupler according to another embodiment of the present disclosure.

FIG. 38 is a perspective cross-sectional view of a coupler according to another embodiment of the present disclosure.

FIG. 39 is a side elevation view, in cross-section, of a dip tube assembly according to one embodiment of the present disclosure.

### DETAILED DESCRIPTION

The present disclosure relates to novel and advantageous generally cylindrically-shaped liner-based storage and dispensing systems. More particularly, the present disclosure relates to novel and advantageous disposable flexible liners for use with generally cylindrically-shaped overpacks, whereby the liner may substantially conform to the interior size and shape of the overpack. More particularly, the liners of the present disclosure may generally comprise a tube-shaped body portion, a top portion that includes a fitment, and a bottom portion that define an enclosed interior for holding a material. The contents of the liner of the present disclosure in some embodiments may be dispensed by pressure dispense without the use of a dip tube, thereby reducing the overall cost of the liner-based system and increasing the amount of material that may be dispensed from the liner.

The liner may comprise one or more layers and may generally have an overall thickness that may be greater than the thickness of liners traditionally used with known generally cylindrically-shaped overpacks. The conformal shape and/or the properties of the film comprising the liner (including the material used and/or the thickness of the liner) may advantageously provide the liner-based system with desirable characteristics, including but not limited to: increased dispensability; reduction or elimination of fold gas, pinholes, and/or weld tears; and/or a reduction in the load and stress on the liner fitment. Because embodiments of liner-based systems of the present disclosure may be used to store, ship, and/or dispense ultrapure, and/or relatively expensive, and in some cases extremely expensive materials, the above-noted advantages may provide significant advantages over prior art liners used with generally cylindrically-shaped overpacks. For example, some ultrapure materials contemplated for use with the liner-based systems of the present disclosure may cost about $2,500/L or more. Thus, even a small reduction of the amount of overflow (i.e., losing some of the contents of the liner during filling because the liner cannot accommodate all of the material), reduction in contamination, or increase in dispensability can be desirable.

Example uses of such liners may include, but are not limited to, transporting and dispensing ultrapure chemicals and/or materials such as photoresist, bump resist, cleaning solvents, TARC/BARC (Top-Side Anti-Reflective Coating/Bottom-Side Anti-Reflective Coating), low weight ketones and/or copper chemicals for use in such industries as microelectronic manufacturing, semiconductor manufacturing, and flat panel display manufacturing, for example. Additional uses may include, but are not limited to, transporting and dispensing acids, solvents, bases, slurries, cleaning formulations, dopants, inorganics, organics, metalorganics, TEOS, and biological solutions, pharmaceuticals, and radioactive chemicals. However, such liners may further be used in other industries and for transporting and dispensing other products such as, but not limited to, paints, soft drinks, cooking oils, agrochemicals, health and oral hygiene products, and toiletry products, etc. Those skilled in the art will recognize the benefits of such liner-based systems and the process of manufacturing the liners, and therefore will recognize the suitability of the liners for use in various industries and for the transportation and dispense of various products.

In some embodiments, the liner of the present disclosure may be configured to be compatible in use with existing overpacks and/or dispensing systems. For example, the liners of the present disclosure may be designed to work in liner-based systems that are required to pass UN DOT tests. As discussed above, packaging or container systems for transporting certain types of materials are required to meet specific UN DOT certifications. For example, to be certified as a non-removable head container for transporting certain hazardous materials, the container opening cannot exceed 3 inches in diameter. Accordingly, liners of the present disclosure may be designed to fit, and in some cases substantially easily fit, within standard container openings for containers meeting UN DOT non-removable head certifications for hazardous materials.

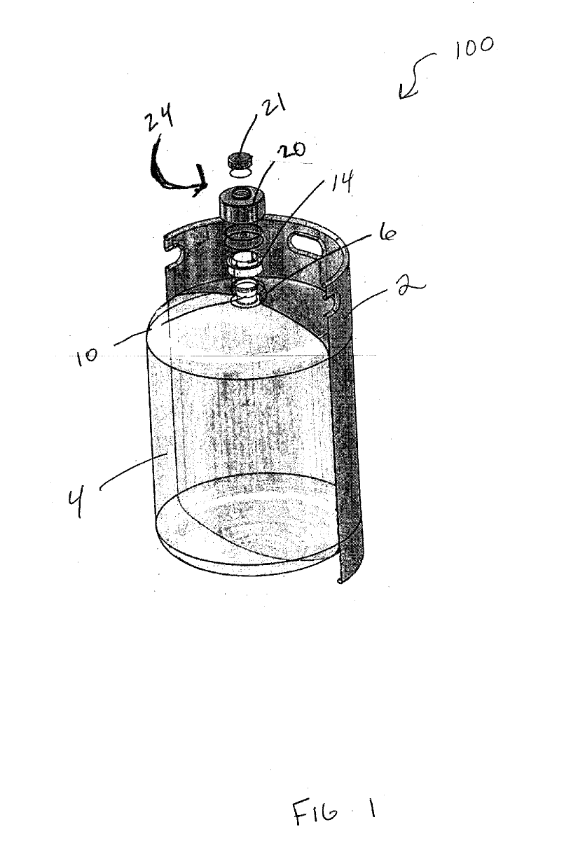

FIG. 1 shows one embodiment of the liner-based system of the present disclosure. The system 100 of FIG. 1 may include an overpack 2 and a liner 4. The overpack 2, in some embodiments, may be generally cylindrically-shaped with a hollow interior capable of receiving a liner 4. In some embodiments the overpack 2 may include traditional overpacks such as existing drums or canisters used for storing and/or dispensing materials, including overpacks with larger mouth openings than that illustrated in FIG. 1 as well as overpacks wherein the entire lid or top opens, for example, and/or overpacks meeting UN DOT certifications for hazardous material, as discussed above. In other embodiments, the overpack 2 may be designed to have a particular shape and/or size. The overpack 2 in some embodiments may have any substantially cylindrical or barrel-like shape and may have any suitable size, including any suitable circumference and/or height. The overpack 2 may be comprised of any suitable substantially rigid material, for example, but not limited to, metal, glass, wood, plastic, composites, corrugated materials, paperboard, or any other suitable material or combination of materials. In some embodiments, the overpack 2 may comprise known drums or canisters of 19 L, 40 L, or 200 L sizes, for example.

The overpack 2 may also include a closure and/or connecting assembly 24. In one embodiment, shown in FIG. 1, the closure and connecting assembly 24 may include a fitment retainer 14, a closure 20, and a shipping cap 21. In embodiments of the present disclosure that include an existing or known overpack 2, the closure and/or connecting assembly 24 that has traditionally been used with the overpack 2 may be used.

In some embodiments, the closure and/or connecting assembly 24 may provide, or the overpack 2 and/or liner 4 may connect with a high-flow connector that provides, a high-flow rate during dispense and/or allows a greater percentage of the contents of a liner to be dispensed than conventional connectors, for example. As shown in FIG. 7, in one embodiment, a high-flow connector 700 may include a pressure port 702, a dispense port 706, a pressure relief valve 708, a headspace removal and/or recirculation port 704, and one or more locking mechanisms or cylinders 710. Examples of such closures and/or connecting assemblies that may be used with some embodiments of the present disclosure are described in detail in U.S. Pat. Application No. 61/438,338, titled “Connectors for Liner-Based Dispense Containers,” which was filed on Feb. 1, 2011 and U.S. patent application No. 12/982,160, titled “Closure/Connector for Liner-Based Dispense Containers,” which was filed on Dec. 30, 2010, each of which is hereby incorporated by reference herein in its entirety. In other embodiments, the closure and/or connecting assembly 24 may be suitably adapted to connect with an overpack of any suitable size and/or shape.

The liner 4 of the system 100 may include a fitment 10 in some embodiments. The liner 4 may be generally cylindrically-shaped such that in an expanded state, the liner substantially conforms to the shape of the interior cavity of the overpack 2. In a collapsed state, the liner 4 may collapse such that the liner 4 may fit through the overpack neck 6 of the overpack 2. The fitment 10 of the liner 4 may be configured such that when the liner 4 is inserted into the overpack 2, the fitment 10 of the liner 4 may nest inside of the fitment retainer 14 and/or the neck 6 of the overpack 2. In some embodiment, the fitment retainer 14 of the overpack 2 may detachably secure to the fitment 10 of the liner 4 and/or the neck 6 of the overpack 2, thereby supporting the liner in the overpack.

The fitment 10 of the liner 4 may be integral with the top portion of the liner 4. The fitment 10 may be sized and shaped such that the fitment 10 may be positioned inside of the fitment retainer 14 and/or the neck 6 of the overpack 2 and/or be compatible with some or all components of the closure and/or connector assembly 24 of the overpack 2. The fitment 10 may be comprised of any suitable material or combination of materials. For example, a suitably rigid plastic such as high density polyethylene (HDPE) may be used. In some embodiments, the fitment 10 may be comprised of a more rigid material than the rest of the liner 4. The fitment 10, in some embodiments may be securely sealed to the liner via welding or any other suitable method or combination of methods. In some embodiments, where for example the overpack includes a centrally-located mouth or opening, the fitment 10 may also be centrally located on the top panel to minimize stress on the fitment weld; however, central location of the fitment 10 on the top panel is not required. As discussed above, some embodiments of the liner of the present disclosure may be configured for use with known overpacks. In such embodiments, the fitment 10 of the liner 4 may be sized and shaped to be compatible with the closure and/or connector assembly 24 of a particular known overpack 2. Such known overpacks may be compatible, for example, with a liner fitment 10 having a ¾ inch or a 2 inch diameter, for example. It will be understood, however, that the liner fitment 10 may have any suitable diameter and/or shape and size such that it is compatible with a desired overpack 2.

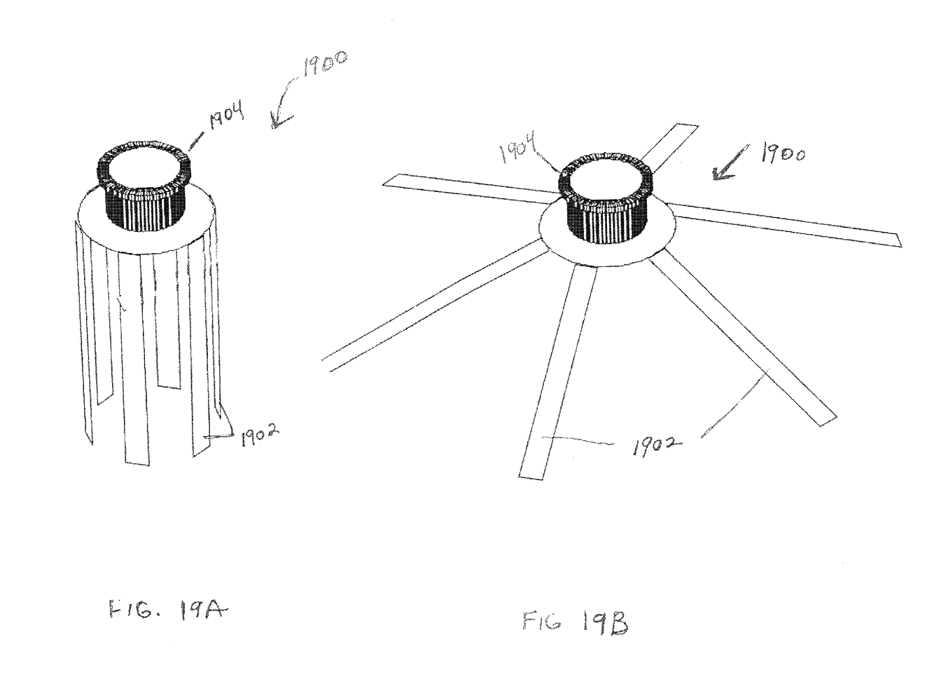

In another embodiment shown in FIGS. 19A and 19B, a modified fitment 1900 may be provided. The modified fitment 1900 may include a plurality of splines 1902 spaced a distance apart. Any suitable number of splines 1902 may be included. Each spline may have any suitable width, length, and/or thickness. In some embodiments each spline may have the same dimensions as every other spline, while in other embodiments, splines may have differing dimensions. Further, one spline may be spaced any suitable distance from the next closest spline(s). In some embodiments, each spline may be spaced substantially equidistant from the adjacent splines, while in other embodiments the plurality of splines may be spaced varying distances from adjacent splines. In some embodiments, the modified fitment 1900 may be affixed to the liner, such as by welding or any other suitable method. In some cases, the splines 1902 themselves may, or may also be, affixed to the interior or exterior of the liner walls, for example by welding or any other suitable means. In other embodiments, the modified fitment 1900 may be affixed to the liner, but the splines may not be affixed to the liner. For example, a liner 4 may have a fitment 10 of the type generally shown in FIG. 1. The modified fitment 1900 may be a fitment adapter that may be inserted into the fitment 10 of the liner, in some embodiments. In some cases, the top portion 1904 of the modified fitment may include a lip or other structure that allows the fitment adapter to securely attach to, or rest on, the liner fitment 10, for example.

The modified fitment 1900 may have a first closed position as shown in FIG. 19A and a second expanded position as shown in FIG. 19B. The closed position may advantageously allow the liner to be inserted into the neck of an overpack, while the open position may provide support for the top portion of the liner. The modified fitment 1900 in one embodiment may be configured such that when the modified fitment is in the closed position shown in FIG. 19A, the splines are held under tension, thereby allowing the splines to substantially automatically (i.e. without further intervention) open up once the modified fitment 1900 has passed through the neck of the overpack. In some embodiments, the splines may relax (i.e. collapse inward) during dispense as the contents are removed from the liner due to the weight of the contents of the liner as the contents are dispensed and/or the pressure in the annular space between the liner and the overpack. The use of a modified fitment with embodiments of the present disclosure may advantageously reduce the risk of pin holes and/or fold gas being created in the liner at least because the top of the liner may be supported by the splines part of the way, or in some cases all of the way, out to the walls of the liner in some embodiments. Further, because the splines may not come completely together in the closed position in some embodiments, choke off may also be reduced and/or substantially eliminated. Generally speaking, choke-off may be described as what occurs when a liner necks and ultimately collapses on itself, or a structure internal to the liner, to form a choke point disposed above a substantial amount of liquid. When a choke-off occurs, it may preclude complete utilization of the liquid disposed within the liner, which is a significant problem, as specialty chemical reagents utilized in industrial processes such as the manufacture of microelectronic device products can be extraordinarily expensive. Additionally, the modified fitment may allow for complete or substantially complete pressure dispense. It will be understood that any of the embodiments of the modified fitment 1900 herein described or contemplated may be used together with any of the various liner embodiments described herein.

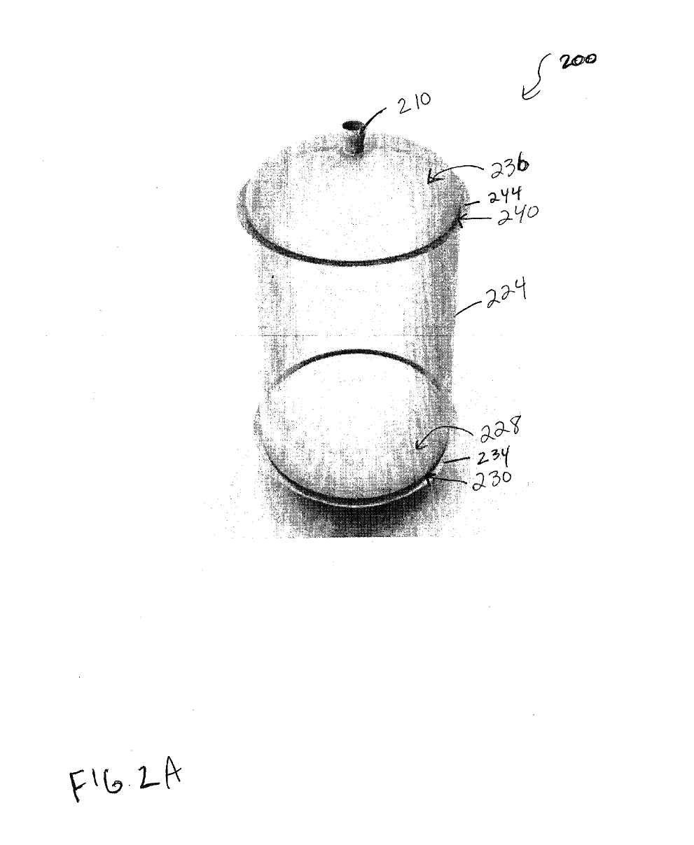

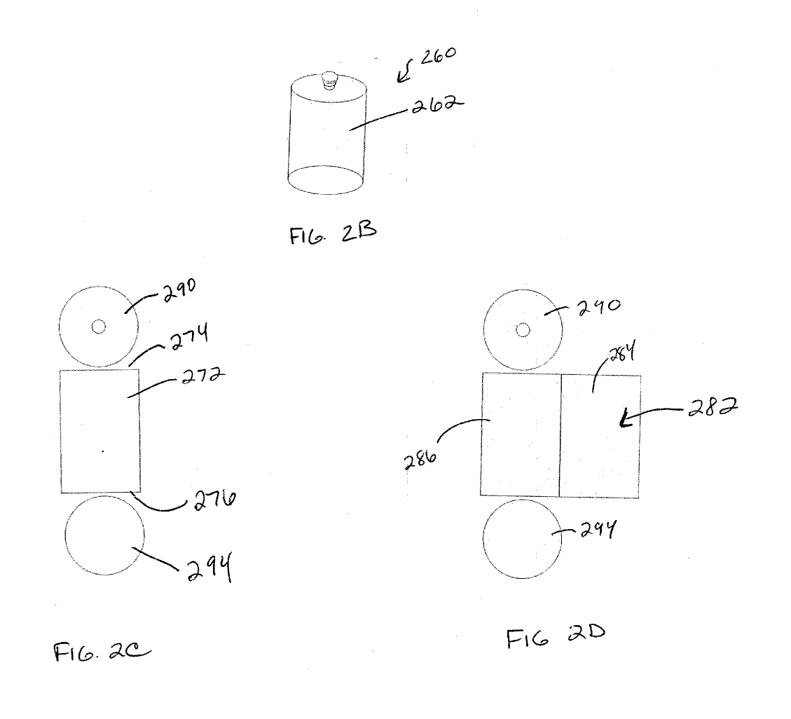

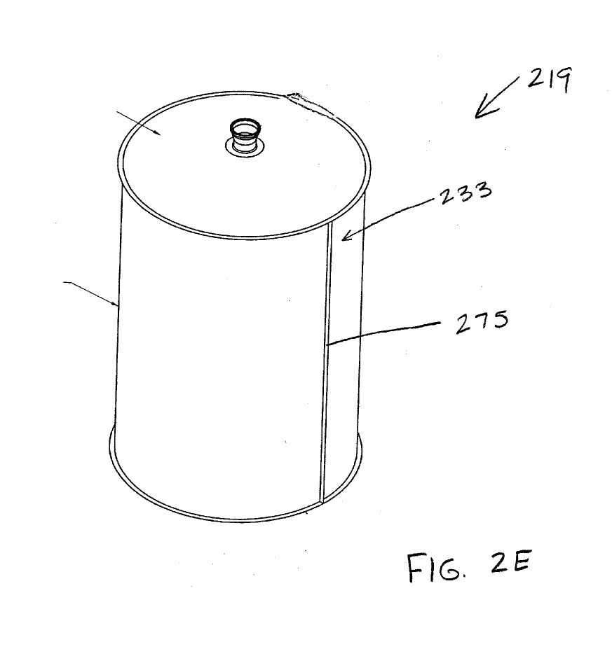

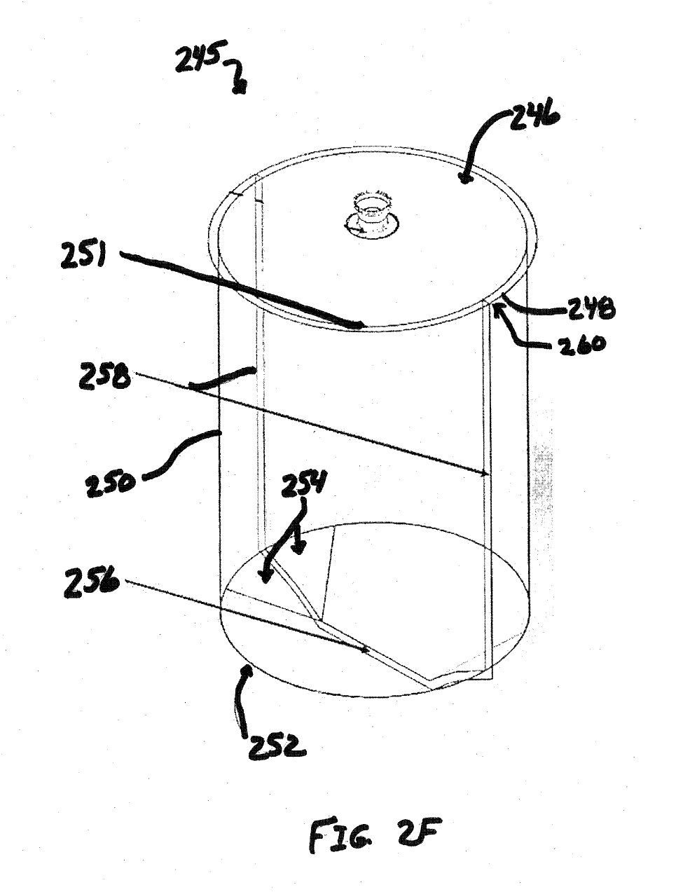

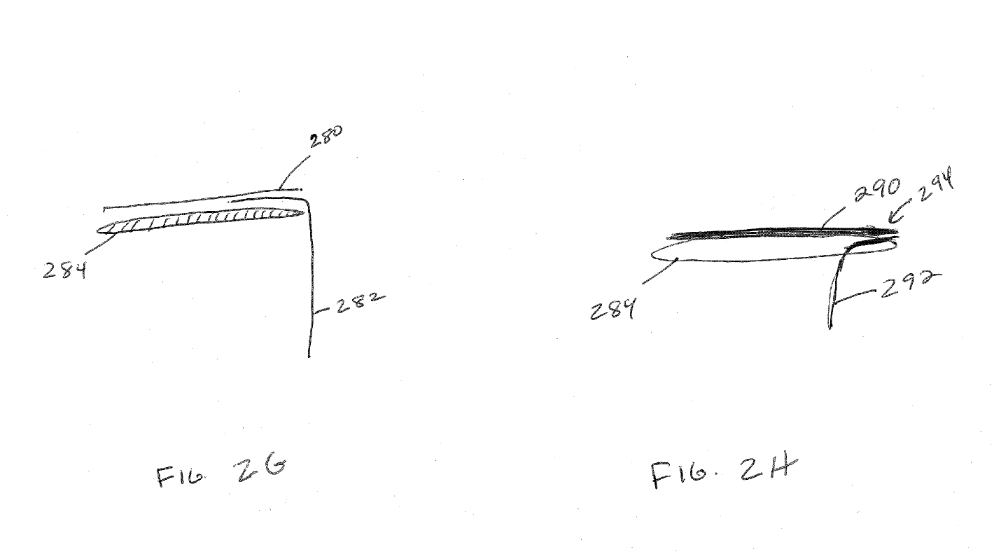

As discussed above and as shown in FIG. 2A, the liner 200 may be generally cylindrically-shaped or barrel shaped when in an expanded or filled state. The liner 200 in some embodiments may be a generally closed liner, in that the liner 200 may comprise an interior space for holding a material that may be filled through or dispensed from the fitment 210. The liner 200 may comprise a body portion 224, a bottom portion 228, a top portion 236, and at least one fitment 210. As may be seen in FIG. 2C, for example, the body portion 272 may be generally tube-shaped with two open ends 274, 276. The body portion 272 may be formed in any suitable manner. For example, the body portion 272 may be formed from a single tubular sheet in some embodiments. In other embodiments, as shown in FIG. 2D, the body portion 282 may be formed from two or more sheets 284, 286 that may be welded together. In still another embodiment shown in FIG. 2E, the ends of a single sheet 233 may be welded together to form a tube, thereby creating a vertical weld seam 275 in the formed liner 219. With reference back to FIG. 2C (but which may also be seen in FIGS. 2B and 2D), the top portion 290 and bottom portion 294 may be generally circular in shape and sized to substantially match the diameter of the open ends 274, 276 of the body portion 272. As may be seen in FIG. 2A, in some embodiments, the top portion 236 and/or the bottom portion 228 may not necessarily expand in a flat configuration, but instead the top portion 236 may be configured to extend above the vertical height of the body portion 224 and/or the bottom portion 228 may be configured to extend below the vertical height of the body portion 224, in order for the liner to better conform to the overpack 2, for example. The bottom portion 228 may be sealed 230 to the tubular body portion 224 via welding or any other suitable method. Similarly, the top portion 236 may be sealed 240 to the opposite end of the body portion 224 via welding or any other suitable method. Stress on the weld of the top portion 236 and/or bottom portion 228 that may attach the top and/or bottom portion to the body portion 224 may be minimized because it is generally circular, and therefore without inherent weak spots, such as corners for example. The circumferential weld may also allow the liner 200 to more substantially conform to the top of the overpack, when the liner 200 is filled.

In some embodiments, the top portion 236 and/or bottom portion 228 may also include a flange 244, 234 that may be created by welding the top 236 and/or bottom portions 228 to the body portion 224. However, in other embodiments, as shown in FIG. 1, the welds may be substantially smooth (e.g., having substantially no, or no exterior, flange).

In some embodiments, the bottom portion may be gusseted, and accordingly may have a weld or seam line. For example, in an embodiment, illustrated in FIG. 2F, the top portion 246 of a liner 245 may be generally circular in shape and sized to substantially match the diameter of a top open end 248 of the body portion 250. As discussed above, the top portion 246 may be sealed 251 to an end 248 of the body portion 250 via welding or any other suitable method. The bottom portion 252, however, may be gusseted, or may be a gusseted portion of the body portion 250, with gusseted sections 254. Thus, in some embodiments, the bottom portion 252 may alternatively, or additionally, have a weld or seam 256 generally across its diameter that aligns with, or is a part of, a vertical weld seam or seams 258 of the body portion 250, as will be understood by those skilled in the art.

Embodiments that include liners portions, e.g., top, bottom, and body portions, that are configured from one or more film sheets welded together to provide a body portion may provide cleaning advantages over liners comprising body portions without more than one panel welded together. This may be the case because it is generally easier to clean a generally flat surface of film for a liner that has not yet been welded together, as opposed to cleaning, for example, a tubular body portion surface for a liner that cannot easily be laid flat. Nonetheless, in other embodiments, the liner of the present disclosure may be formed by blow-molding or any other suitable molding process.

In some embodiments the top portion and/or the bottom portion may advantageously be welded to the body portion while the material to be welded is in a substantially flat position. For example, as may be seen in FIG. 2G, the tubular body portion 282 may be fitted over a structure, such as a ring or disc 284, with the body portion generally on an external side of the ring and with a suitable or desirable amount of an edge of the tubular body portion laid over a top surface of the ring and extending inward. The top portion 280 may then be positioned over the ring and the edge of the tubular body portion 282 for welding by a suitable welding apparatus, thereby creating a welded seam around the circumference of the body portion 282 and the top portion 280. This may create an internal weld, such that no external flange is provided. The same process may be performed at the opposite end of the tubular portion and the bottom portion such that the bottom portion may be welded to the opposite end of the tubular body portion.

In another embodiment shown in FIG. 2H, the body portion 292 may be fitted generally on an internal side of the tube or ring 284 with a suitable or desirable amount of an edge of the tubular body portion laid over a top surface of the ring and extending outward. The top portion 290 may then be positioned over the ring and the edge of the tubular body portion 292 for welding by a suitable welding apparatus, thereby creating a welded seam around the circumference of the body portion 292 and the top portion 290. This may create an external weld flange 294 at the perimeter of the top portion and top edge of the tubular body portion. The same process may be performed at the opposite end of the tubular portion and the bottom portion such that the bottom portion may be welded to the opposite end of the tubular body portion. In some embodiments, external flanges may be desirable for purposes of cleanliness, as there would be no internal weld or flange.

Embodiments that include a top and/or bottom seam around the circumference of the body portion and where the body portion also includes one or more vertical seams, an intersection area may be created where the vertical seam(s) may intersect with the top and/or bottom seam. Such an intersection 260 may be seen on FIG. 2F. Generally speaking, areas where one or more seams or welded areas intersect can have a tendency to be relatively structurally weaker than other non-welded or non-seamed areas. In one embodiment, the risk of the intersection area being or becoming weaker may be substantially eliminated or reduced by selecting particular films and/or film designs and/or by including enough bonding material during the welding process, such that the welds, and therefore the intersection area may be strengthened. Alternately, or in addition, the intersection area may be re-welded to strengthen the area. Further, in some embodiments applying more heat for a longer period of time during the welding process may reduce the potential for weakness at the intersection areas.

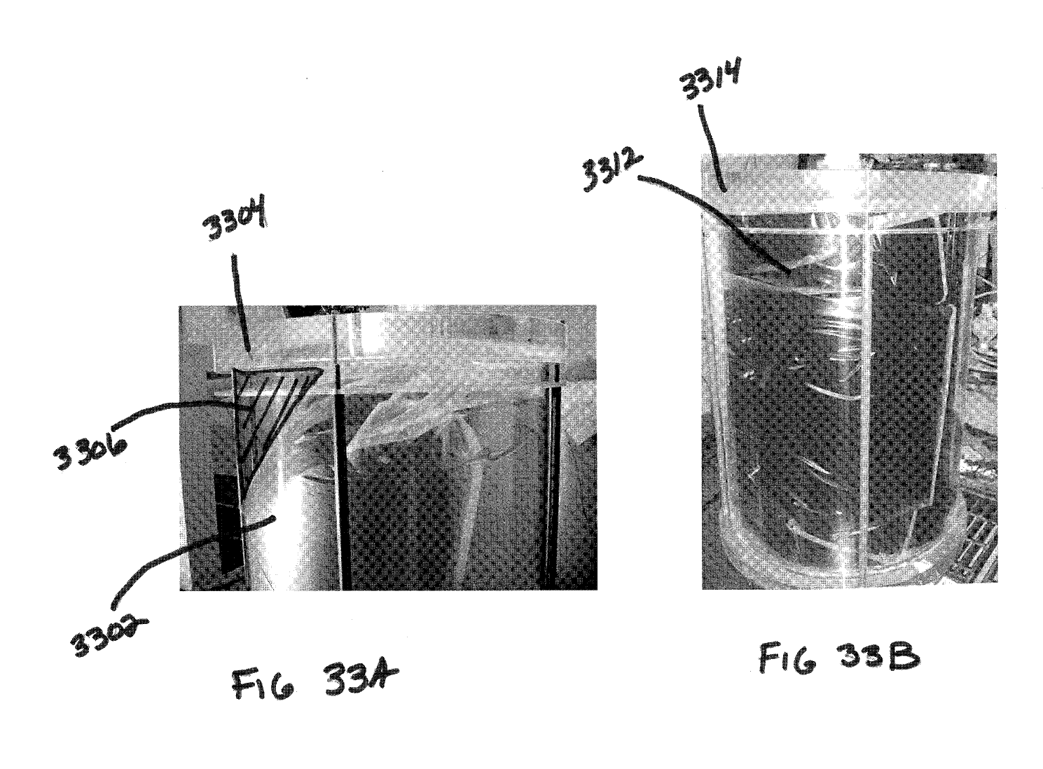

The shape of the liner of the present disclosure may be configured to generally or substantially conform to the interior space of the generally cylindrical overpack and therefore may advantageously increase the dispensability that may be achieved. Further, the shape of the liner of the present disclosure may decrease or eliminate fold gas, pinholes and/or weld tears during transport. Some traditional non-cylindrical liners, for example pillow type liners with a fitment located at the top portion on one side of the liner, may not fully utilize all of the interior space available within an overpack, as may be seen in FIG. 33A. During filling of such a liner 3302, the liquid may generally force a pillow type liner toward the bottom of an overpack 3304, which generally causes the top of the liner to pull downward, increasing the unused space 3306 between the liner and the top of the overpack. As a result of the downward force that may be exerted on the filled pillow type liner 3302, the fitment and top weld may be subjected to additional and/or undesirable stress.

In contrast to traditional pillow type liners or other two dimensionally shaped liners, because the liner of the present disclosure may substantially conform to the overall shape of the overpack when the liner is full, the liner may not tend to pull downward and away from the top of the overpack, as may be seen in FIG. 33B. Instead, the liner 3312 may be filled generally to the top of the overpack 3314, with minimal stress on the circumferential top weld or the fitment area. Further, because the liner of the present disclosure in some embodiments may substantially conform to the shape of the overpack, the liner may not generally fold in upon itself, which could otherwise potentially cause the contents of the liner to become trapped. The shape of the liner in some embodiments may thus eliminate or reduce the existence of such folds that can create air pockets that may contaminate the contents of the liner. As such, fold gas (gas that may be trapped in the folds of the liner when the liner is filled) may be decreased in embodiments of the present disclosure versus traditional pillow type liners. For example, tests were performed that measured fold gas in 200 L pillow type liners versus 200 L conformal liners according to embodiments of the present disclosure, and on average, fold gas was decreased by about 100-300 mL in the conformal liner of the present disclosure compared to the pillow type liner.

The substantially conformal shape of the liner to the overpack may also help support the liner in the headspace region, may decrease the tendency of the liner to fold on itself, and may limit the amount of fluid motion that occurs during shipping and/or transport that could otherwise cause micro folds to flex, and could result in pinholes or weld tears. For example, tests were performed based on ASTM standard tests to determine the failure rate of 200 L pillow type liners and 200 L liners of the present disclosure of varying film types. For purposes of the test, a failure was defined as the development of a pinhole or weld tear in the liner. Specifically, the tests evaluated 200 L pillow type liners and 200 L liners of the present disclosure of varying film types at Truck Level IV for 50 hours. Upon completion of the tests, none of the liners of the present disclosure failed, while ⅓ of the pillow type liners failed. The results of the test did not seem affected by the type of film used to make the liners.

As explained above, in some cases liners may be filled with expensive materials, and in some cases extremely expensive materials. Accordingly, reducing or eliminating the potential for overflow (i.e., losing some of the contents of the liner during filling because the liner cannot accommodate all of the material) may be advantageous. One way to reduce or eliminate the risk of overflow is by increasing the capacity of the liner for holding liquid contents. Liners of the present disclosure in some embodiments may have increased content volume relative to other liners designed for holding a similar volume because the amount of volume wasted by excess folds in the liner and trapped gas may be decreased. Accordingly, a conformal liner of the present disclosure configured to hold 200 L may actually accommodate about 2 to 10 more liters of overflow volume compared to traditional liners. Increasing the capacity of the liner may reduce, substantially reduce, or eliminate the risk of overflow for liners of the present disclosure, in some embodiments. The substantially conformal shape of the liner to the overpack may also reduce the load and stress on the fitment and fitment weld of the liner of the present disclosure in some embodiments.

In some embodiments, the overall thickness of the liner may be thicker than traditional liners used with drum style overpacks. One advantage of a liner with a thickness greater than traditional liners may be that the increased thickness can help prevent or reduce the occurrence of pin holes (small holes that can form in the liner), fold gas, weld tears, and/or gas diffusion that may occur during filling, storage, shipment, and/or dispense. The increased thickness of the liner may also help prevent choke-off during dispense.

The above-noted advantages associated with liner of the present disclosure may be particularly important when the contents of the liner are ultrapure contents that may be both relatively or substantially more expensive than other types of stored and/or shipped materials and that are much more likely to become unusable if contaminated. While the overall thickness of embodiments of the present disclosure may be greater than that of traditional liners, the thickness may not be so great as to prevent the liner from being inserted into or extracted from the overpack through the neck of the overpack when the liner is in a collapsed state. Accordingly, any suitable thickness of the liner 200 is contemplated by the present disclosure. For example, in some embodiments, the liner 200 may have an overall thickness from about 80 to about 280 microns. In further embodiments, the liner 200 may have an overall thickness from about 100 to about 220 microns. In still other embodiments, the liner 200 may have an overall thickness from about 150 to about 200 microns. In still other embodiments, the liner 200 may have an overall thickness from about 100 to about 150 microns. However, even thicker liners may be used, particularly with overpacks having larger mouth openings than those illustrated as well as overpacks wherein the entire lid or top opens, for example. As used here and throughout the present disclosure, ranges are used as a short hand for describing each and every value that is within the range; any value within the range can be selected as the terminus of the range.

The liner 200 of the present disclosure may comprise one, two, or more layers made from one or more suitable materials. In some embodiments, for example, the liner may consist of two or more layers, whereby the two or more layers may be made from the same material or may be made from different materials. Each of the one or more layers may have any suitable thickness. In some embodiments with two or more layers, each layer may have the same thickness, while in other embodiments, the two or more layers may have different thicknesses. In some embodiments, the one or more layers of the liner may be free of plasticizers, heat stabilizers, colorants, flame retardants, mold release agents (DMPS) and/or other microelectronic contaminants.

In some embodiments, the inner layer of the liner, or in embodiments comprising a single layer, the surface of the layer that makes contact with the contents of the liner may be comprised of a chemically compatible material. For example, the inner or wetted layer may be comprised of, for example, but may not be limited to, linear low-density polyethylene (LLDPE), polyethylene (PE), polytetrafluoroethylene (PTFE), perfluoroalkoxy (PFA), fluorinated ethylene propylene copolymer (FEP), polyethylene naphthalate (PEN), polyethylene terephthalate (PET), polybutylene terephthalate (PBT), or any other suitable material or combination of materials. In some embodiments, the outer or protective layer or layers, may generally consist of a relatively more robust material that may act as a moisture and/or gas barrier to prevent contamination of the contents of the liner through the liner walls. Additionally, the one or more outer layers may have additional properties to ensure that the liner remains intact and resistant to cracks, tears, pin holing or other degradation that may occur during shipping and/or storage. The one or more outer layers may be comprised of but are not limited to, polyethylene (PE), polybutylene terephthalate (PBT), polyamides (PA), polypropylene (PP), ethylene vinyl alcohol (EVOH), polyethylene naphthalate (PEN), polyethylene terephthalate (PET), or any other suitable material and/or combination of materials.

In some embodiments the liner may also include any number of additional barrier layers that may be positioned between an inner layer and one or more outer layers. An additional barrier layer or layers may help keep the contents of the liner from seeping out of the liner as well as help keep gas and/or other contaminants from seeping into the interior of the liner. The barrier layers, in some embodiments, may be comprised of, for example ethylene-vinyl alcohol copolymer (EVOH), nylon or any other suitable material or combination of materials, such as any of those materials identified above.

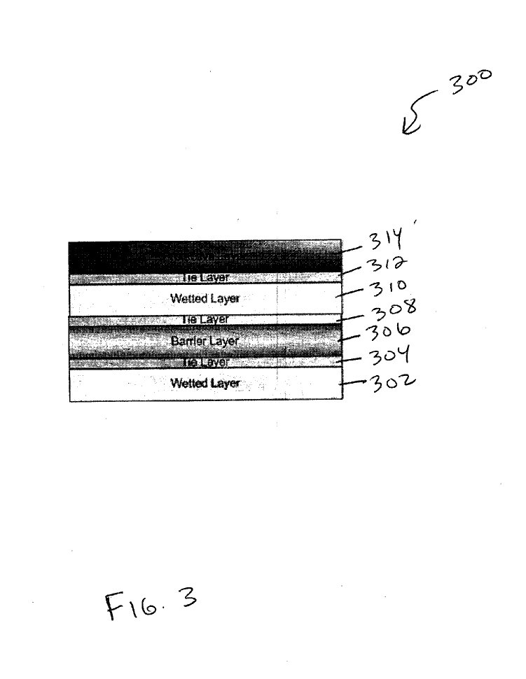

Embodiments of the liner of the present disclosure that include two or more layers may be configured such that the layers may be arranged in any suitable order and/or combination. For example, as may be seen in FIG. 3, which shows a cross-section of a liner 300, in one embodiment a liner may include an inner or wetted layer 302, a barrier layer 306, a second inner layer 310, and a protective or outer layer 314. Any two layers may have one or more tie layer 304, 308, 312 between them. While FIG. 3 shows one configuration of possible layers of a multi-layer liner, it will be understood that any other suitable combination of layers is within the spirit and scope of the present disclosure. For example, in one embodiment, a liner may include an inner or wetted layer 302, a barrier layer 306, and a second inner layer 310 (which may be the outer layer), with potentially one or more tie layers 304, 308 between them. As discussed above, each of the layers of a multi-layer liner 300 may have any suitable thickness that may or may not be the same thickness as the other layers of the liner 300. In some embodiments, the thickness of one or more of the non-tie layers may be from about 5 to about 140 microns. In further embodiments, the thickness of one or more of the non-tie layers may be from about 10 to about 120 microns. In still further embodiments, the thickness of the one or more of the non-tie layers may be from about 15 to about 100 microns. It will be understood, however, that the one or more layers of a multi-layer liner may have any suitable thickness.

The liner of the present disclosure may have a relatively simplistic design with a generally smooth outer and/or inner surface, or the liner may have a relatively complicated design, including, for example, but not limited to, pleats, ridges, indentations and/or protrusions. In one embodiment, for example, the liner may be textured to prevent choke-off, that is, the liner may be textured to prevent the liner from collapsing in on itself in a manner that would trap liquid within the liner and preclude the liquid from being dispensed properly.

The film comprising the liner of the present disclosure may be formed by any suitable process or combination of processes. For example, the film for the liner may be formed by co-extrusion, extrusion blow molding, injection blow molding, injection stretch blow molding, or any other suitable method or combination of methods. Examples of the types, properties, and methods of manufacturing the film that may be used in some embodiments of liners of the present disclosure are described in detail in International PCT Patent Application No. PCT/US11/55558, filed on Oct. 10, 2011, titled “Substantially Rigid Collapsible Liner, Container and/or Liner for Replacing Glass Bottles, and Enhanced Flexible Liners” and U.S. patent application No. 61/499,254 filed on Jun. 21, 2011, titled “Substantially Rigid Collapsible Liner, Container and/or Liner for Replacing Glass Bottles, and Flexible Gusseted or Non-Gusseted Liners,” which are each hereby incorporated herein in its entirety.

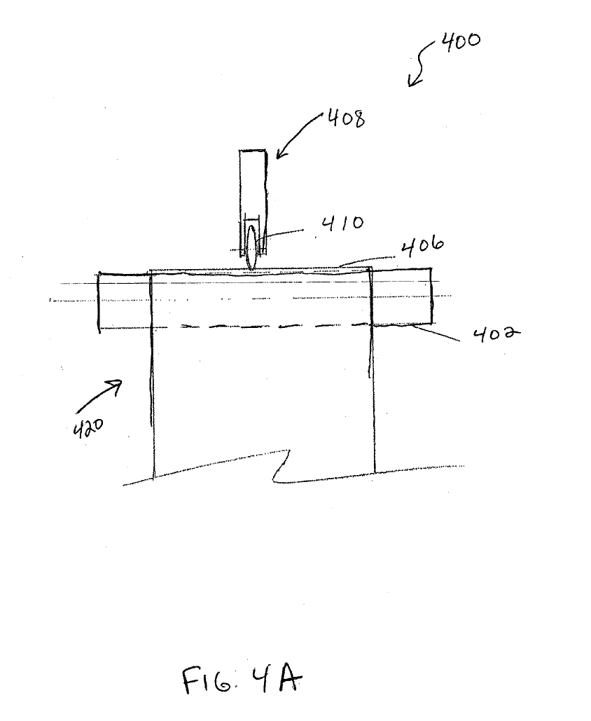

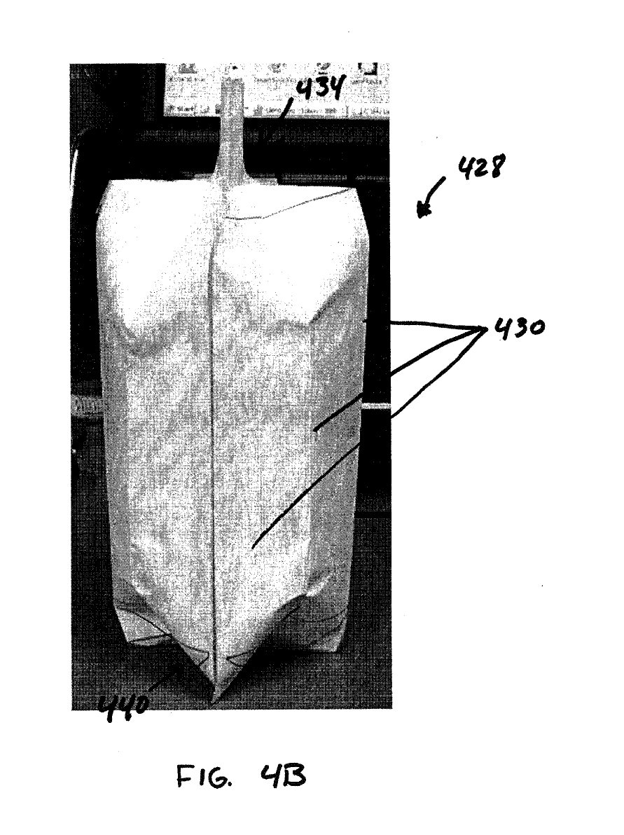

In some embodiments, the liner may be shaped to assist in dispensability of the liquid from within the interior cavity. In one embodiment of a liner for use with an overpack, illustrated in FIG. 4B, a liner 428 may include one or more pre-folds or fold lines 430 that may extend a vertical distance of the liner 428, and in some cases extend substantially the entire vertical distance of the liner 428, from the fitment 434 to the bottom 440. Fold lines 430 may be molded into the liner or added subsequent the molding process. Fold lines 430 may be designed to control the collapsing or folding pattern of the liner 428. Any suitable number of fold lines 430 may be provided in the liner. The fold lines 430 may be suitably configured to control the collapsing or folding pattern of the liner 428 and reduce or minimize the number of particles that may be shed from the liner 428 during collapse. The fold lines 430 may be configured such that they reduce or minimize the resulting number of fold lines and/or gas trap locations within the liner upon complete or near complete collapse of the liner 428. A variety of fold patterns that may be used with embodiments of the present disclosure are described in International PCT Patent Application No. PCT/US11/55558 and U.S. patent application No. 61/499,254, which were previously incorporated by reference in their entirety.

In still other embodiments, as illustrated in FIG. 4C, a liner 442 may have any desired shape, including a shape that may not substantially conform to the shape of the overpack 446. For example, in some cases, the liner 442 may indeed be a pillow-type liner, a gusseted liner or any other suitable liner. Examples of such liners that may be used with embodiments of the present disclosure are described in International PCT Patent Application No. PCT/US11/55558 and U.S. patent application No. 61/499,254, which were previously incorporated by reference in their entirety. Such liners may be advantageously used in some embodiments with relatively small liner and overpack systems, such as for example, with liners that generally hold no more than 19 L. It will be recognized, however, that non-conformal liners may also be configured to hold greater than 19 L of material. Smaller liners configured to hold less material may be made in some embodiments with a relatively thinner film. Non-conformal liners may be used with or without dip tubes, as described herein with reference to other embodiments.

In use, the liner 4 may be inserted into the overpack 2 when the liner 4 is in a collapsed state through the neck 6 of the overpack 2. In this manner, liner 4 may be designed to work in liner-based systems that are required to pass UN DOT tests, including those for removable and non-removable head containers. For example, liner 4 may be designed to fit, and in some cases substantially easily fit, when in a collapsed state, within standard container openings for a container meeting UN DOT non-removable head container certifications for hazardous materials, which in some cases must not exceed 3 inches in diameter. Once the liner 4 has been positioned inside of the overpack 2, the liner 4 may be expanded to an expanded state that may substantially conform to the shape of the interior of the overpack 2. In some embodiments, the liner may be inflated with a clean gas, for example, but not limited to N₂, or clean dry air, prior to filling the liner with the desired material, while in other embodiments the liner may be expanded with the chemical to be filled. After the liner 4 has been filled with the desired material, the closure and/or connector assembly 24 of the overpack may be detachably secured to the fitment 10 of the liner 4. The system 100 may then be shipped to a desired location or stored until shipped. Upon arrival at a desired location, the contents of the liner 4 may be dispensed.

Traditionally, the contents of liners for use with drum style overpacks are dispensed by pump dispense. Accordingly, typically a dip tube may be used in conjunction with the liner and overpack in order to pump the contents out of the liner. Pump dispense may generally fail to consistently achieve as high a rate of dispense as other dispense methods, for example pressure dispense. Further, the dip tube used during pump dispense can be relatively expensive, particularly as the dip tube is typically disposed of after a single use. Advantageously, the contents of the liners of the present disclosure in some embodiments may be dispensed by pressure dispense without the use of a dip tube. As such, the dispensability of some embodiments of liners of the present disclosure may be higher, and the overall cost of the system may be less than that of known liners.

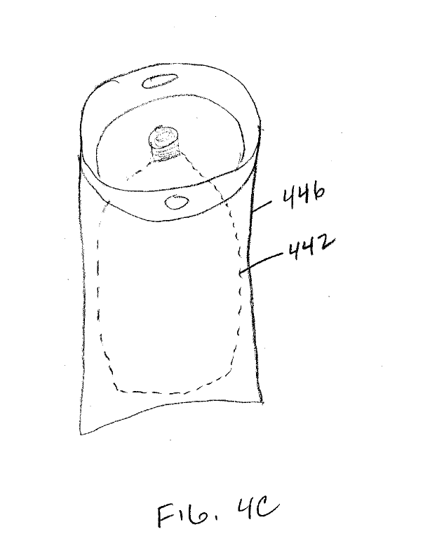

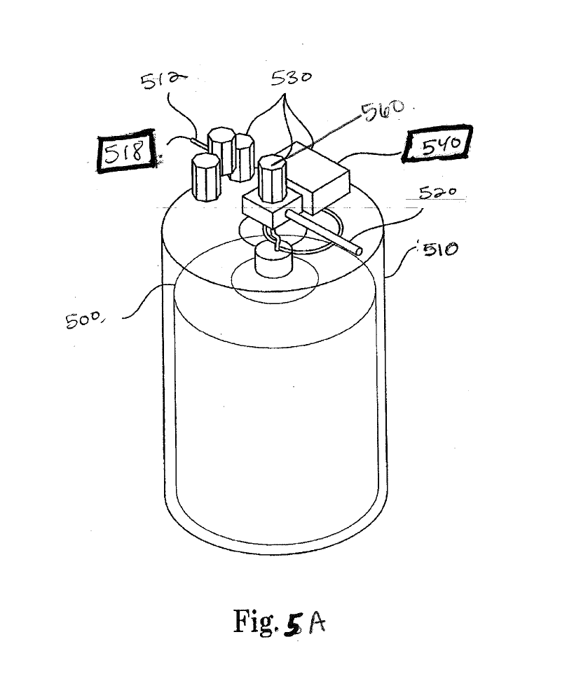

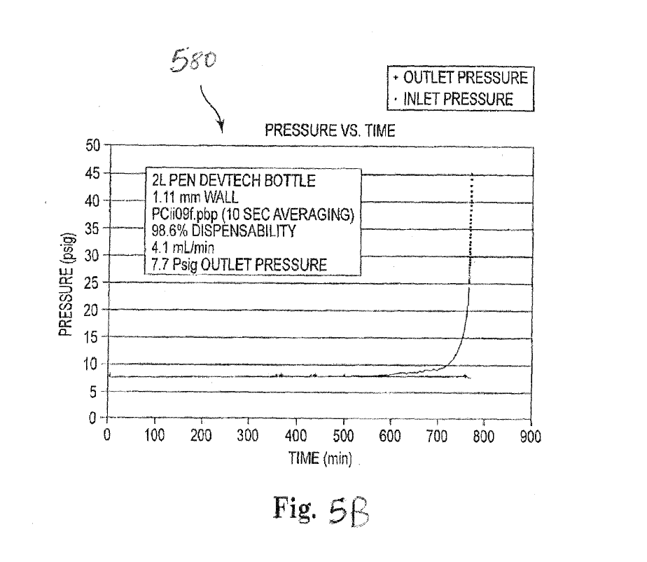

In one embodiment, to dispense liquid stored in the liner, a pressure source may be connected to the liner-based system, wherein a gas or fluid may be introduced into the annular space between the outside of the liner and the inside wall of the overpack causing the liner to collapse and expel the contents of the liner out of the fitment of the liner. As may be seen in FIG. 5A, in some embodiments, the liner 500 may be placed in an overpack 510. A gas inlet 512 can be operably coupled to a gas source 518 to introduce gas into the space between the overpack 510 wall and the liner 500 wall in order to collapse the liner 500 and pressure dispense the liquid stored within the liner through a liquid outlet 520. In some embodiments, the overpack 510 may also include control components 530 to control the incoming gas flow and outgoing liquid flow. A controller 540 can be operably coupled to control components 530 to control the dispense of the liquid from the liner 500.

The amount of pressure required to dispense the contents of a liner of the present disclosure may depend on the force required to collapse the liner, which may be dependent on the thickness and/or composition of the liner. In some embodiments, the contents of the liner may be dispensed at any suitable pressure. For example in one embodiment, the contents may be dispensed at from about 7 psig to about 30 psig.

Generally, the outlet liquid pressure may be a function of the inlet gas pressure. Typically, if the inlet gas pressure remains constant, the outlet liquid pressure may also be generally constant in the dispensing process but decreases near the end of dispense as the liner nears empty. Means for controlling such dispense of fluid from the liner are described for example in U.S. Pat. No. 7,172,096, titled “Liquid Dispensing System,” issued Feb. 6, 2007, PCT Application Number PCT/US07/70911, titled “Liquid Dispensing Systems Encompassing Gas Removal,” with an international filing date of Jun. 11, 2007, and PCT Application Number PCT/US2011/020236, titled “Liquid Dispensing Systems with Gas Removal and Sensing Capabilities,” with an international filing date of Jan. 5, 2011, each of which is hereby incorporated herein by reference in its entirety.

In embodiments where inlet gas pressure is held generally constant, as further described in detail in PCT Application Number PCT/US07/70911, the outlet liquid pressure can be monitored. As the liner nears empty, the outlet liquid pressure decreases, or droops. Detecting or sensing such decrease or droop in outlet liquid pressure can be used as an indication that the liner is near empty, thereby providing what may be referred to as droop empty detect.

In some embodiments, however, it can be desirable to control the outlet liquid pressure such that it is substantially constant throughout the entire dispensing process. In some embodiments, in order to hold the outlet liquid pressure substantially constant, the inlet gas pressure and outlet liquid pressures may be monitored, and the inlet gas pressure may be controlled and/or vented in order to hold the liquid outlet pressure constant. For instance, relatively low inlet gas pressure may be required during the dispensing process due to the relatively full nature of the liner, except when the liner is near empty. As the liner empties, higher inlet gas pressure may generally be required to further dispense the liquid at a constant outlet pressure. Accordingly, the outlet liquid dispensing pressure may be held substantially constant throughout the dispensing process by controlling the inlet gas pressure, as can be seen in FIG. 5B, which shows the inlet gas pressure increasing as the liner nears complete dispense.

At a certain point in the dispensing process, the amount of inlet gas pressure required to empty the liner can quickly become relatively high, as shown in the graph 580 of FIG. 5B. In some embodiments, monitoring the rising inlet gas pressure throughout the dispensing process may be used to provide an empty detect mechanism. For example, in one embodiment, the inlet gas pressure may be monitored, and when the inlet pressure reaches a certain level, it may be determined that the liner is empty and the dispensing process is complete. An empty detect mechanism such as this may help save time and energy, and consequently money.

For example, in some embodiments the inlet gas pressure and/or the liquid outlet pressure may be monitored and/or controlled during dispense. With reference back to FIG. 5A, in some embodiments, the liquid outlet pressure may be sensed by an outlet pressure transducer 560, for example. The signal from the outlet pressure transducer 560 may be read by the controller 540. If the liquid outlet pressure is too low, the inlet gas pressure on the area between the liner 500 and the overpack 510 may be increased via one or more inlet solenoids, for example, which may comprise a portion of the control components 530. If the liquid outlet pressure is too high, the area between the liner 500 and the overpack 510 may be vented by one or more venting solenoids, for example, which may comprise a portion of the control components 530. A pressure sensor positioned in the annular space between the liner 500 and the overpack 510 may determine if the dispensing end point has been reached, for example, if the high inlet gas pressure limit has been reached, as described above, or by any other suitable method of determining when dispensing should end.

In further embodiments, the liner-based system of the present disclosure may be configured such that it is compatible with the NOWPak® pressure dispense system, such as that disclosed in U.S. patent application No. 11/915,996, titled “Fluid Storage and Dispensing Systems and Processes,” which was filed Jun. 5, 2006, the contents of which are hereby incorporated by reference in their entirety herein. A sample of a misconnect prevention connector that may be used with the liner-based system of the present disclosure may be that of ATMI of Danbury, Conn., or those disclosed in U.S. patent application No. 60/813,083 filed on Jun. 13, 2006; U.S. patent application No. 60/829,623 filed on Oct. 16, 2006; and U.S. patent application No. 60/887,194 filed on Jan. 30, 2007, which are all hereby incorporated herein by reference in their entirety.

Advantageously, the lack of dip tube or use of a shortened dip tube, or use of a long dib tube with a port at the top, can enable the removal of headspace gas in the liner prior to dispensing of the contents from the liner. Generally, the expression “headspace,” as used herein, may refer to the gas space in the liner that may rise to the top of the liner, above the contents stored in the liner. By removing headspace gas prior to content dispense, gas that is in direct contact with the liquid can be reduced or substantially eliminated, such that the amount of gas dissolved into the liquid during the dispense process is significantly reduced or minimized. Liquid with minimal dissolved gas generally has less tendency to release gas bubbles after experiencing a pressure drop in the dispense train, and thus, substantially reducing or eliminating gas bubble issues in the liquid dispense system. Generally, headspace in the liner may be removed or reduced by first pressurizing an annular space between the liner and the overpack via a pressure port so that the liner begins to collapse, thereby forcing any excess headspace gas out of the liner through a headspace removal port, or other suitable outlet port.

Due to the shape, thickness and composition of some embodiments of the liner of the present disclosure, the dispensability rate may be above 90%, desirably the dispensability may be above 97%, and more desirably up to 99.9% dispensability depending on the thickness of the liner wall, and/or the material used for the liner. For example, on pressure dispense tests performed on six 200 L liners of the present disclosure, with a choke-off preventer as described herein, the residual in each liner after pressure dispense was completed was less than 100 ml (0.05%), with the average being about 40 ml (0.02%).

Tests performed comparing one embodiment of a liner of the present disclosure with two other commercial liners (referred to herein as Commercial Liner 1 and Commercial Liner 2) demonstrate the advantages of some embodiments of liners of the present disclosure. A single-ply liner of the present disclosure used in the comparative testing included layers of LLDPE, a tie layer, EVOH, another tie layer, and another LLDEP layer, with a total thickness of approximately 100 μm. This liner will be referred to herein as “NS50.” The two commercial liners tested were each two-ply, three-dimensional liners made by two separate companies. The tests performed and described below include: N₂ permeability; particle shedding in deionized (“DI”) water; total organic carbon (“TOC”) in DI water; and trace metal (“TM”) in DI water and 5% nitric acid. The N₂ permeability test was performed separately on the single-ply of the NS50, and each of the inner and outer plies of the commercial liners. The analytical tests were performed on pouches made of the single-ply of the NS50 and each of the double-ply commercial liners. Each test performed was carried out substantially identically on each of the samples and/or each of the different films that were tested.

Permeability Testing

For the permeability test, two 4″×4″ film samples were prepared for each of the NS50 and the inner and outer plies of Commercial Liner 1 and Commercial Liner 2. Each of the samples was tested on a Mocon Multi-Tran 400 instrument. The test gas used was N₂ with 0% RH. The carrier gas was 100% helium with 0% RH, and the test temperature was 23° C., i.e. room temperature. The N₂ transmission rates in cc/(100 in². day) were recorded, as shown in the table below:

| Sample No. | 1 | 2 |
|---|---|---|
| NS50 | 0.3 | 0.3 |
| Commercial Liner 1 Inner | 16.5 | 13.9 |
| Commercial Liner 1 Outer | 17.1 | 15.9 |
| Commercial Liner 2 Inner | 35.0 | 31.3 |
| Commercial Liner 2 Outer | 33.1 | 30.3 |

As may be seen from the foregoing results, the NS50 samples had two orders of magnitude lower N₂ transmission rate than each of the commercial liner samples.

Particle Testing

The particle testing was carried out using sample 5.5″×11.5″ pouches that were created from each of the NS50, Commercial Liner 1, and Commercial Liner 2. The pouches were each filled with DI water, sealed, and gently rotated to wet all surfaces. Particle concentrations were measured using a Rion KS-16 liquid particle counter. The data is shown in the graph below:

As may be seen from the foregoing results, the NS50 samples, on average, had an order of magnitude less particle shedding than the Commercial Liner 1 samples and four orders of magnitude less particle shedding than the Commercial Liner 2 samples.

TOC Testing

The Total Organic Carbon (“TOC”) testing preparation was carried out in the same manner as the particle testing described above. TOC was measured using a Sievers 900 TOC analyzer at the beginning of the test (T=0) and on the seventh day of the test (T=7). The data is shown in the graph below:

As may be seen from the foregoing results, at T=0, the TOC levels for the NS50 samples were, on average, about the same as the TOC levels for the Commercial Liner 1 samples and about ½ to ⅓ of the TOC levels for the Commercial Liner 2 samples. At T=7, the TOC levels for the NS50 samples were, on average, about ⅖ of the TOC levels for the Commercial Liner 1 samples and about 1/10 of the TOC levels for the Commercial Liner 2 samples.

TM Testing

The trace metal (“TM”) testing preparation was also carried out in the same manner as the particle testing described above. Trace metals were measured using an Agilent 7500 ICP-MS machine at the beginning of the test (T=0), on the seventh day of the test (T=7), and on the thirtieth day of the test (T=30). Trace metal testing was performed in DI water and 5% nitric acid.

TM in DI

The T=0, T=7, and T=30 day data is shown in the graph below:

As may be seen from the foregoing results, trace metal levels in DI for the NS50 and Commercial Liner 1 samples were comparable, but trace metal levels for the Commercial Liner 2 samples were significantly higher.

TM in 5% Nitric Acid

The T=0, T=7, and T=30 day data is shown in the graph below:

As may be seen from the foregoing results, trace metal levels in 5% nitric acid for the NS50 and Commercial Liner 1 samples were comparable, but trace metal levels for the Commercial Liner 2 samples were significantly higher.

As may be seen from the above testing, some embodiments of the present disclosure may have various advantages over other known liners. One advantage, as indicated by the foregoing test results, may include increased ability to maintain purity of the contents of the liner.

Some embodiments of the present disclosure as described herein have been described as not having a dip tube, however it will be recognized that some embodiments of the present disclosure may include a small tube that extends from the fitment and/or connector into the interior of the liner a relatively short distance so that the contents of the liner may be directed out of the fitment of the liner. An apparatus of this type in some cases may be referred to as a “stubby probe,” examples of which are described in detail in U.S. patent application No. 11/915,996, the contents of which were previously incorporated herein by reference in its entirety.

In other embodiments of the present disclosure, the liner-based system may include a dip tube. In such embodiments, the hollow dip tube may be integral with, or separate from, the connector of the closure and/or connector assembly. In this regard, the contents within the liner may be received directly from the liner via the dip tube. In some embodiments of a liner that includes the use of a dip tube, the dip tube may also be used to pump dispense the contents within the liner, including by using existing pump dispense systems for dispense.

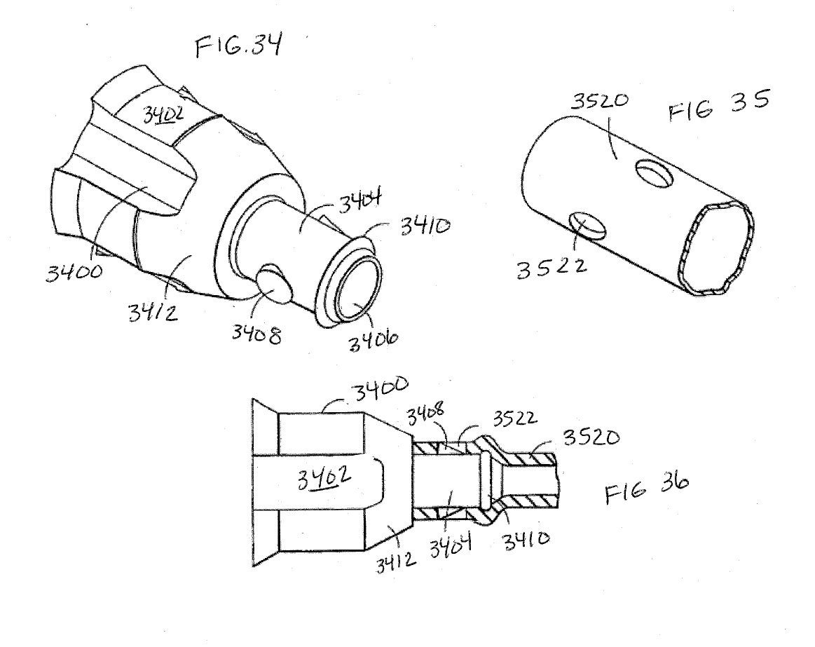

One embodiment of a dip tube is shown in FIGS. 34 and 35. FIG. 34 illustrates a perspective view of a coupler 3400 constituting part of a snap-fit dip tube assembly according to one embodiment of the invention. The coupler 3400 comprises a generally cylindrical main portion 3402 at its proximal end. The main portion 3402 may be joined at its distal end to a frustoconical transition portion 3412, which may be joined in turn to a cylindrical distal portion 3404 having an open distal end 3406 communicating with a central passage in the coupler. On its exterior cylindrical surface, the distal portion 3404 may have snap-in-place protrusion elements 3408 that may be generally wedge-shaped with a thin distal end portion and a thick proximal end portion, for mateable engagement with tubing as hereinafter more fully described.

The distal portion 3404 at its distal extremity may have a sealing feature in the form of a circumscribing ring protrusion or ridge 3410. The generally cylindrical main portion 3402 of the coupler 3400 may, as illustrated, be formed with conformational features to enable ready gripping of the coupler by an assembler.

FIG. 35 is a perspective view of tubing 3520 having holes 3522 therein for snap-engagement with the snap-in-place protrusions 3408 of the coupler. The tubing 3520 may as shown be formed with two holes 3522 for engaging a corresponding number of snap-in-place protrusions 3408 of the coupler, however one or more than two such holes and a corresponding number of protrusions on the coupler can be utilized in specific embodiments. The tubing in this embodiment may also be formed with a circumferential groove therein so that the sealing feature 3410 on the cylindrical distal portion 3404 mateably generally engages such groove when the distal portion 3410 is inserted into the tubing 3520 to a predetermined extent.

FIG. 36 is an elevational, cross-sectional view of the coupler and tubing of FIGS. 34 and 35 as engaged with one another, with the protrusions 3408 disposed in the holes 3522 and with the sealing feature 3410 reposed in the interior groove of the tubing 3520. The resulting snap-together dip tube assembly may be readily assembled without flaring, swaging, or other labor-intensive and time-consuming operations.

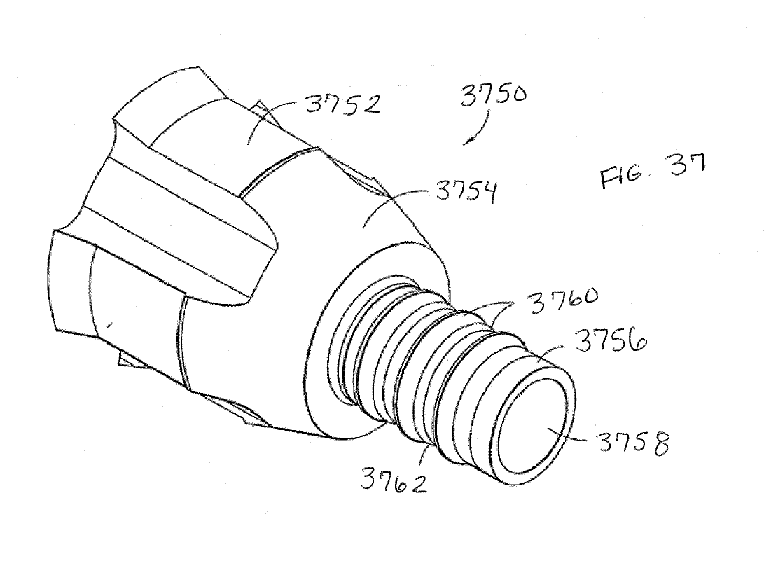

FIG. 37 is a perspective view of a coupler 3750 according to another embodiment of the invention. The coupler 3750 has a proximal, generally cylindrical portion 3752 of relatively larger average diameter in relation to a generally frustoconical transition portion 3754 of intermediate average diameter in relation to a distal tubular portion 3756 having a bore 3758 therethrough of smallest diameter in relation to the other two portions of the coupler. The distal tubular portion 3756 may have an undulant wall circumscribing the bore 3758, and characterized by a series of ridges 3760 alternating with a series of respective depressions 3762. The undulant surface profile of the distal portion of the coupler may enable the coupler to be mated in secure fashion with a corresponding section of tubing.

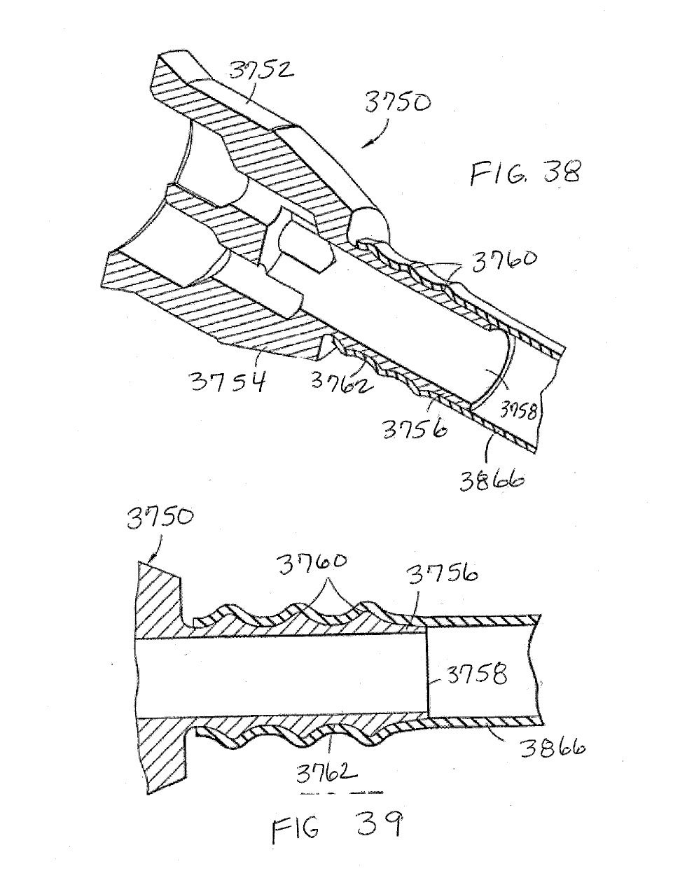

Referring now to FIG. 38, there is shown a coupler 3750, all parts and elements being correspondingly numbered in respect to the reference numbers set out in FIG. 37. The coupler 3750 may be mated with the tubing 3866 so as to provide a unitary dip tube assembly. In this assembly, the ridges or “bumps” on the distal tubular portion 3756 of the coupler may serve to deform the tubing 3866. This arrangement thus generally provides a gripping force exerted by the tubing on the exterior surface of the distal portion of the coupler, as well as eliminating air pockets and potential chemical traps that may impair the function of the dip tube if the tubing were not in close contact with the exterior surface of the coupler. FIG. 39 is a side elevation view, in cross-section, of the dip tube assembly 3750, showing the profile of the tubing 3866 on the exterior surface of the distal portion of the coupler.

Some embodiments of the present disclosure may further include components or methods for further reducing or eliminating choke-off. As stated above, generally speaking, choke-off may be described as what occurs when a liner necks and ultimately collapses on itself, or a structure internal to the liner, to form a choke point disposed above a substantial amount of liquid. A variety of ways of preventing or handling choke-off are described in PCT Application Number PCT/US08/52506, entitled, “Prevention Of Liner Choke-off In Liner-based Pressure Dispensation System,” with an international filing date of Jan. 30, 2008, which is hereby incorporated herein by reference in its entirety. Additional examples of components and/or methods for limiting or eliminating choke-off are also described in detail in U.S. patent application No. 61/499,254, which was previously incorporated herein by reference in its entirety.

In addition, in some embodiments, choke-off may be eliminated or reduced by providing a choke-off preventer as shown in FIG. 6. The choke-off preventer may be configured to be operably secured to existing liner fitments and/or special adaptors for use in coupling the choke-off preventer to the liner fitment or the dispense connectors. The preventer 600 may include a flexible, generally spiral-shaped wrap tube 604 comprised of any chemically compatible material, for example PE, PFA, PTFE, or any other suitable material or combination of materials. In some embodiments, the preventer 600 may also include a sheath 606 that may surround the wrap tube 604. As with the wrap tube 604, the sheath 606 may be comprised of any chemically compatible material. The wrap tube 604 may be comprised of the same material as or a different material than the sheath 606. The preventer head 602 may be inserted into the fitment of the liner, while the wrap tube 604 may extend any suitable distance into the liner itself. The spiral wrap tube 604 may help keep a channel open as the liner collapses during dispense to ensure a continuous flow of material. Because the preventer 600 may work in part due to its vertical positioning in the liner and also due to gravity, in some embodiments, the preventer 600 may have a flexible wrap tube 604 to ensure the proper positioning of the preventer 600. In some embodiments, the wrap tube 604 may have varying weights or different features at different sections of the wrap tube 604. For example, the wrap tube 604 may be more rigid in the general area where the wrap tube 604 couples to the preventer head 602. Additionally, the end of the wrap tube 604 furthest from the preventer head 602 may be heavier than other sections of the wrap tube 604, such that the heavier end may tend toward the bottom of the liner, in some embodiments. In a test using the preventer 600 with a 200 L liner of the present disclosure, dispensability of 99.95% was achieved. Further, in some embodiments, the preventer 600 may be disposable and configured for a one-time use. In some embodiments, the preventer 600 may also be used as a dip tube.

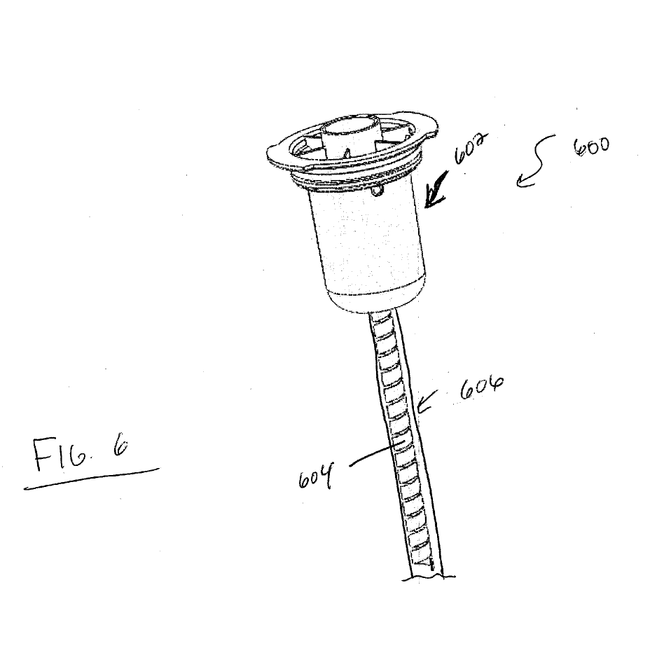

In another embodiment, as shown in FIGS. 8 and 9, an elongated tube 802, 902 may extend into a liner to assist in preventing choke-off. The tube 802, 902 may have any geometry, including being substantially cylindrical, or any other shape. In some embodiments, the tube 802, 902 may have a plurality of holes 806, 906 cut into the body of the tube 802, 902. As may be seen in FIG. 8, in one embodiment, the holes 806 may be arranged in columns, for example, thereby forming longitudinal ribs in the side wall of the tube 802. In another embodiment, shown in FIG. 9, the holes 906 may be offset, in a pattern or randomly, relative to one another. The holes 806 may be rectangular as shown in FIG. 8, for example, or the holes 906 may be circular as shown in FIG. 9, for example. In other embodiments, the holes may have any suitable geometry, including holes with varying geometries. The tube may extend any suitable distance into the liner and may be comprised of any suitable material or combination of materials including, but not limited to, plastic, metal, or glass. Further such choke-off prevention tubes are disclosed and described in greater detail, for example, in U.S. patent application No. 11/285,404, titled “Depletion Device for Bag in Box Containing Viscous Liquid,” filed Nov. 22, 2005, which is hereby incorporated herein by reference in its entirety.

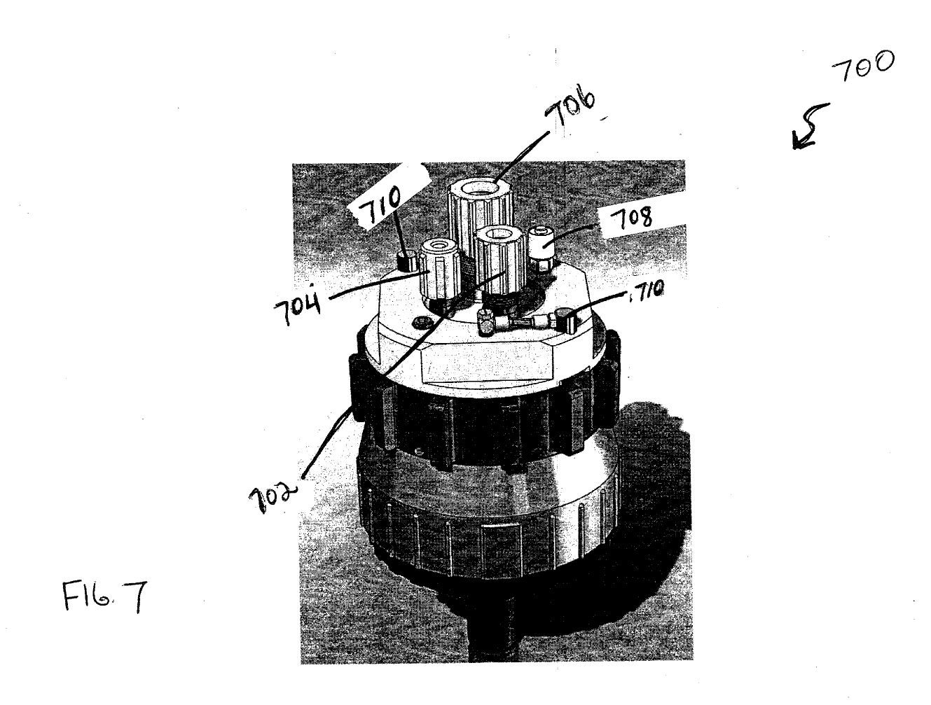

In another embodiment, as shown in FIG. 10, a tube 1000 may be inserted into a liner. The body 1002 of the tube may have a spiraled, spring-like, or coiled shape, for example, in order to prevent or reduce choke-off. Tubes of this type are further disclosed and described, for example, in U.S. Pat. No. 4,138,036, titled “Helical Coil Tube-Form Insert for Flexible Bags,” filed Aug. 29, 1977, which is hereby incorporated herein by reference in its entirety.

In yet another embodiment, choke-off may be reduced or prevented by inserting a tube into a liner, wherein the tube may have a plurality of spring members that connect the fitment of the liner to the tube. In some embodiments, the tube may be similar to the tubes shown in FIG. 8, 9, or 10, for example. Tubes of this type are further disclosed in greater detail, for example, in U.S. Pat. No. 7,004,209, titled “Flexible Mounting for Evacuation Channel,” filed Jun. 10, 2003, which is hereby incorporated herein by reference in its entirety.

In additional embodiments, the surface of the inner or wetted layer of a liner may be deformed during the liner manufacturing process in order to help prevent liner choke-off. For example, in some embodiments, as may be seen in FIG. 4A, a spline tool 408 may be positioned to come into contact with the surface of the inner or wetted layer 406 of a liner as the liner layer progresses through a conventional liner manufacturing machine 420. While only one spline tool is shown, in some embodiments multiple spline tools 408 may be used. The one or more spline tool 408 may include a heated wheel 410 whereby the temperature of the wheel 410 may be held above the melt point of the inner layer 406. With an appropriate and sufficient amount of pressure being applied by the heated wheel 410 to the surface of the inner layer 406, the surface of the inner layer 406 may advantageously be deformed into a non-planar surface. In some embodiments, the one or more spline tool 408 may remain stationary as the wheel 410 makes contact with the surface of the inner layer 406, while in other embodiments the spline tool 408 may be made to oscillate side to side, for example, as the liner layer 406 progresses through the liner manufacturing machine 420.

In another embodiment, the liner manufacturing machine 420 may include a heated roller 402 that may have surface topography etched onto it such that when the inner layer 406 makes contact with the heated roller 402, the surface of the inner layer 406 may advantageously be deformed into a non-planar surface. While the above specific embodiments have been described in detail, it will be understood that any other suitable method or combination of methods for deforming the inner layer and/or any other layer of the liner of the present disclosure is contemplated.

Another method for preventing choke-off in some embodiments may be seen in FIG. 11, which shows a cross-section of a contractible layer 1100 that may be attached to a surface of a liner. A contractible layer 1100 may attach to the inner wall of a liner, for example. The contractible layer 1100 in some embodiments may be comprised of a laminate 1102 of two dissimilar materials. For example, one material may be non-hygroscopic and the other material may be hygroscopic. When moisture or liquid is introduced into the liner, the hygroscopic layer of the contractible layer 1100 may expand causing the contractible layer 1100 to generally curl and form a thick tube that may prevent the liner from choking-off during dispense. Further such apparatus are described, for example, in U.S. Pat. No. 4,524,458, titled “Moisture Responsive Stiffening Members for Flexible Containers,” filed Nov. 25, 1983, which is hereby incorporated herein in its entirety.

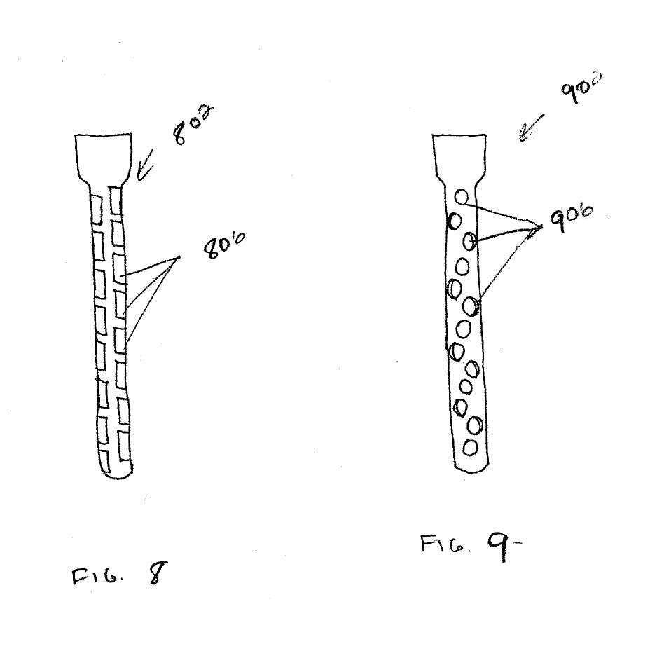

In other embodiments, a strip may be fixedly or detachably attached, or in other embodiments may be integral with a liner, in order to help prevent choke-off. As may be seen in FIG. 12, a strip 1202 may have a plurality of channels, which will also necessarily form a corresponding plurality of raised portions 1206. The strip 1202 may be formed of any suitable material, or combination of materials including the same material as the liner, or a different material than the liner. The strip 1202 may be comprised of one or more layers and/or one or more materials. The one or more strips 1202 may be positioned inside of the liner, for example, and/or attached to the fitment, in some embodiments. Such strips are further disclosed in U.S. Pat. No. 4,601,410, titled “Collapsed Bag with Evacuation Channel Form Unit,” filed Dec. 14, 1984, which is hereby incorporated herein in its entirety. Alternately, one or more strips 1202 may be affixed to the exterior surface of the liner film, such that the film conforms to the generally ridged shape of the strip 1202. Such strips are further disclosed in U.S. Pat. No. 4,893,731, titled “Collapsible Bag with Evacuation Passageway and Method for Making the Same,” filed Dec. 20, 1988, which is hereby incorporated herein by reference in its entirety. In still another embodiment, the strip 1202 may be integral with the film of the liner, examples of which are further described in detail in U.S. Pat. No. 5,749,493, titled “Conduit Member for Collapsible Container,” filed Nov. 10, 1987, which is hereby incorporated herein by reference in its entirety.

In some embodiments, the strip 1202 may be sized such that the strip 1202 may be attached, for example, but not limited to, by welding to the top and/or bottom of the liner. For example, the strip 1202 may be welded into the weld lines of the liner at the top and/or bottom of the liner. Examples of such strips according to this embodiment are further disclosed in detail in U.S. Pat. No. 5,915,596, titled “A Disposable Liquid Containing and Dispensing Package and Method for its Manufacture,” filed Sep. 9, 1997, which is hereby incorporated herein in its entirety. The strip 1202 may be placed at any suitable position relative to or integral with the liner. For example, in some embodiments, the strip 1202 may be located centrally or off-center. In other embodiments, the strip 1202 may be attached to the liner but may be relatively distant from the liner fitment. Suitable placements for the strip 1202 are further described in detail, for example, in U.S. Pat. No. 6,073,807, titled “Flexible Container with Evacuation From Insert,” filed Nov. 18, 1998, and U.S. Pat. No. 6,045,006, titled “Disposable Liquid Containing and Dispensing Package and an Apparatus for its Manufacture,” filed Jun. 2, 1998, each of which is hereby incorporated herein in its entirety.

In some embodiments, a liner may be made by a process wherein a strip may be advanced by a machine or a person a predetermined length during the manufacturing of the liner, such that a liner may be formed that may include an inserted strip. An example of such a process is described in further detail in U.S. Pat. No. 6,027,438, titled “Method and Apparatus for Manufacturing a Fluid Pouch,” filed Mar. 13, 1998, which is hereby incorporated herein by reference in its entirety. In some embodiments, the skirt portion of the liner fitment may also have channels to further reduce choke-off. Examples of such types of channels in the skirt portion are further described, for example, in U.S. Pat. No. 6,179,173, titled “Bib Spout with Evacuation Channels,” filed Oct. 30, 1998, and U.S. Pat. No. 7,357,276, titled “Collapsible Bag for Dispensing Liquids and Methods,” filed Feb. 1, 2005, each of which is hereby incorporated herein by reference in its entirety.

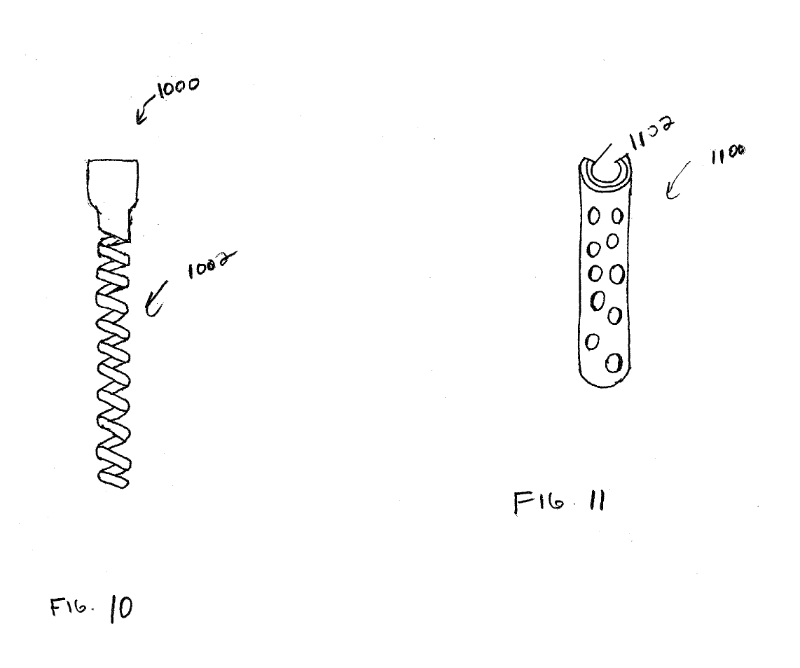

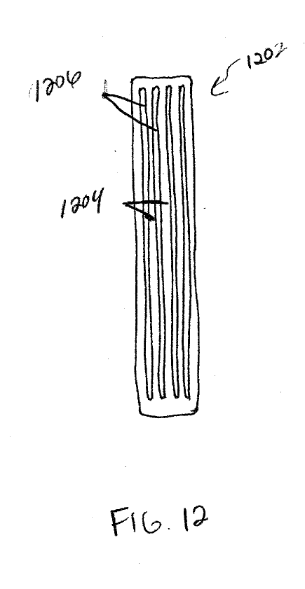

Another method for reducing or preventing choke-off may include, in some embodiments, inserting a corrugated rigid insert 1300, as shown in FIG. 13, into a liner. In some embodiments, the width of the corrugated rigid insert 1300 can be up to substantially the same width as that of the liner. In another embodiment, the insert 1400 may be relatively narrower than the width of the liner, as shown for example in FIG. 14. In some cases, such as shown in FIG. 14, the insert 1400 may be generally U-shaped, but in other cases, the insert 1400 may have any suitable geometry, for example, but not limited to a C-shape, H-shape, or any other suitable shape. The insert 1400 may also be perforated 1402, in some embodiments. Because the insert 1400 may be narrower than the liner in some embodiments, the insert 1400 may include one or more arms 1404 that may be generally the same width as the liner in order to support the insert 1400 in the liner. In another embodiment, shown in FIG. 15, a liner 1502 may have integral vertical ribs 1506 on the interior surface of the liner to help reduce or prevent choke-off when the liner is collapsed. Further such inserts are described in detail in U.S. Pat. No. 2,891,700, titled “Collapsible Containers,” filed Nov. 19, 1956, which is hereby incorporated herein by reference in its entirety.

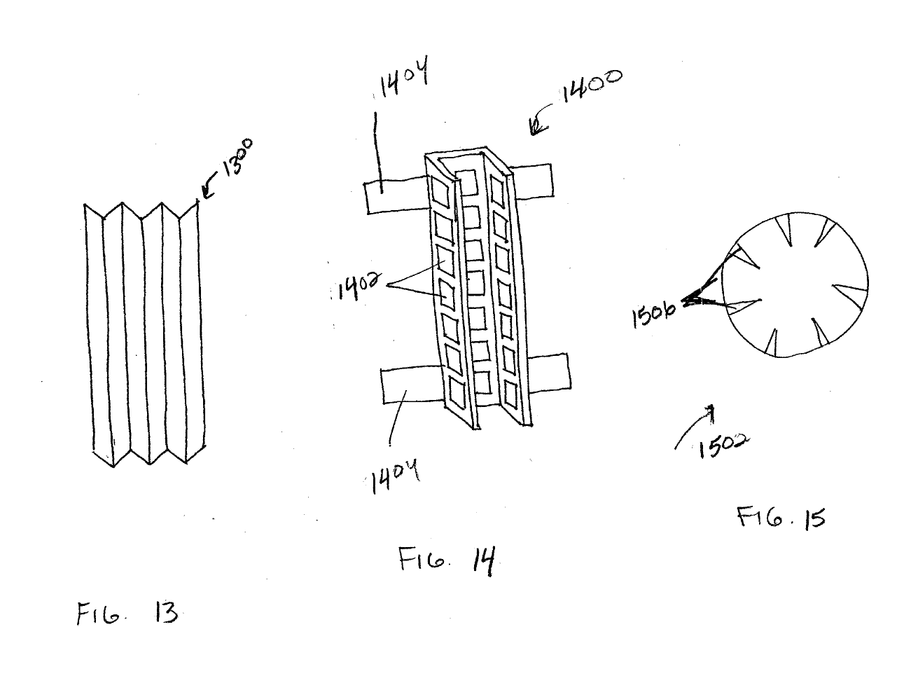

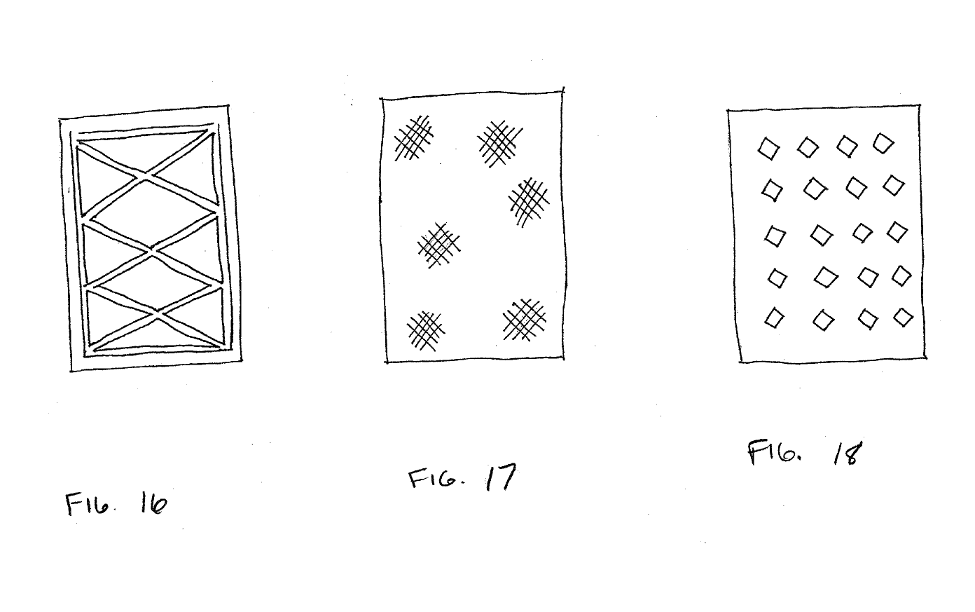

In other embodiments, choke-off may be prevented by altering the surface structure of the film of the liner. For example, FIGS. 16-18 illustrate a variety of different patterns that may be applied to the interior surface of a liner. In some embodiments, the structures may comprise integrated grooves, such grooves being further described, for example, in U.S. Pat. No. 7,017,781, titled “Collapsible Container for Liquids,” filed Aug. 2, 2005, which is hereby incorporated herein in its entirety. Alternately, the structure may comprise a plurality of features on the interior surface of the liner that may define a plurality of pathways by which the contents of the liner may flow, such pathways being further described in detail, for example, in U.S. Pat. No. 6,715,644, titled “Flexible Plastic Container,” filed Dec. 21, 2001, which is hereby incorporated herein by reference in its entirety. Features or structures may be incorporated into the liner film by, for example, mechanically or ultrasonically embossing the features into the film or by using bubble cushion, sealed pleats or accordion folds, for example. Integral features according to such embodiments are further described, for example, in U.S. Pat. No. 6,607,097, titled “Collapsible Bag for Dispensing Liquids and Method,” filed Mar. 25, 2002, and U.S. Pat. No. 6,851,579, titled “Collapsible Bag for Dispensing Liquids and Method,” filed Jun. 26, 2003, each of which is hereby incorporated herein by reference in its entirety. Surface features including protrusions may be formed on the surface of the liner in some embodiments by molding and quenching heat sealable resins. Features formed according to such embodiments are further disclosed in detail, for example, in U.S. Pat. No. 6,984,278, titled “Method for Texturing a Film,” filed Jan. 8, 2002, and U.S. Pat. No. 7,022,058, titled “Method for Preparing Air Channel-Equipped Film for Use in Vacuum Package,” filed Jun. 26, 2002, each of which is hereby incorporated herein in its entirety.

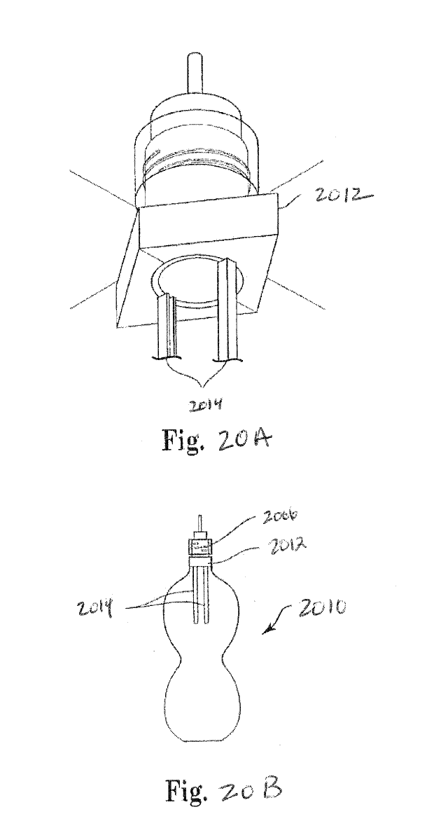

In still other embodiments, choke-off may be eliminated or reduced by providing a channel insert inside the liner, as shown in FIGS. 20A and 20B. Providing a channel insert, such as that shown and described, as well as other suitable embodiments of the channel insert, may help to keep the liner from collapsing in on itself. Because the channels create a passageway that keeps the walls from fully meeting with one another, an opening for fluid to flow out of the liner may be provided that would otherwise be trapped. Channel insert 2014 may be integral with a fitment 2012, which may be positioned in the mouth 2006 of the liner 2010, as described previously. In other embodiments, channel insert 2014 may be detachably secured to the fitment 2012. Channel insert 2014, in some embodiments, may have a cross-section that is generally U-shaped. However, it is recognized that in other embodiments, the channel insert may have a cross-section that is generally V-shaped, zigzagged, curved, or any other suitable cross-sectional shape which creates a barrier to prevent the walls from fully meeting with one another and allows fluid, which would otherwise be trapped, to flow to the fitment 2012. While the channel insert(s) shown in FIGS. 20A and 20B includes two channels, it will be appreciated by those skilled in the art that any other suitable number of channels, including but not limited to a single channel, is within the spirit and scope of the present disclosure. The channels may descend into the liner any distance sufficient to ameliorate the effects of choke-off, such as but not limited to, approximately ⅔ of the way down the liner, ½ of the way down the liner, ⅓ of the way down the liner, or any other suitable distance, which in some embodiments, may depend on the shape of the liner and/or the area or areas of the liner with the highest probability of being a choke-off area. In one embodiment, an advantage of using relatively shorter channel inserts is that they do not interfere so much with collapse of the liner, and thus may not greatly impede dispensation of fluid from the liner.

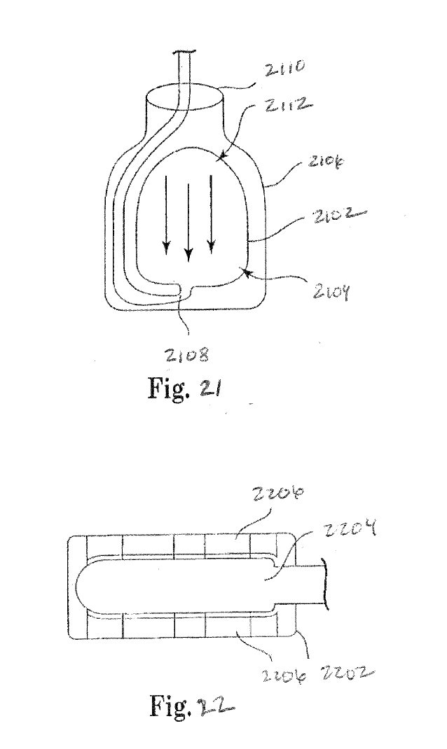

In other embodiments gravity may be used to help dispense the contents of a liner. As shown in FIG. 21, a liner 2102 may be inserted into an overpack 2106. The liner may have a delivery tube that in some embodiments may be a rigid delivery tube 2108 made of, for example, any suitable plastic or other material or combination of materials. The delivery tube 2108 may be generally positioned at the fitment end of the liner. Whereas most embodiments of liners described herein position the fitment end of the liner upwards at the top of the overpack, the delivery tube/fitment end of the liner in this embodiment may be placed in an overpack first, such that the delivery tube end of the liner 2104 is positioned at the bottom of the overpack and the closed end of the liner 2112 is positioned toward the top of the overpack 2106 when the liner is filled. The delivery tube 2108 may extend from the delivery tube end of the liner 2104 to and through the mouth 2110 of the overpack 2106. Upon dispense, the contents of the liner will drain from the bottom of the liner 2112 first. During, for example, pressure or pump dispense, the liquid in the liner 2102 will move downward toward the dispense tube 2108. Due to the force of gravity, the liquid may dispense through the dispense tube 2108 without creating creases or folds that may trap the liquid.

In another embodiment, a liner and overpack system may use a dispense method that includes pumping a liquid that is heavier than the contents of the liner into the area between the overpack and the liner. The buoyancy of the contents of the liner created by the liquid outside of the liner being heavier may lift the liner and collapse the bottom of the liner which may help the dispense process.

In yet another embodiment, as seen in FIG. 22, a liner 2204 may be inserted into an overpack 2202 that may contain one or more bladders 2206. The bladders 2206 may be made of an elastomeric material in some embodiments, while in other embodiments the bladders 2206 may be made of any suitable material. The bladders 2206 may be inflated by a pump, for example, such that when they inflate they press on the liner to uniformly collapse the liner. In some embodiments, the bladder 2206 may be a serpentine like bladder that inflates in a generally coil-like way to press the contents of the liner out. In other embodiments, the bladders 2206 may be coupled to an elastic or spring-like device to ensure that the bladders inflate at substantially the same rate.

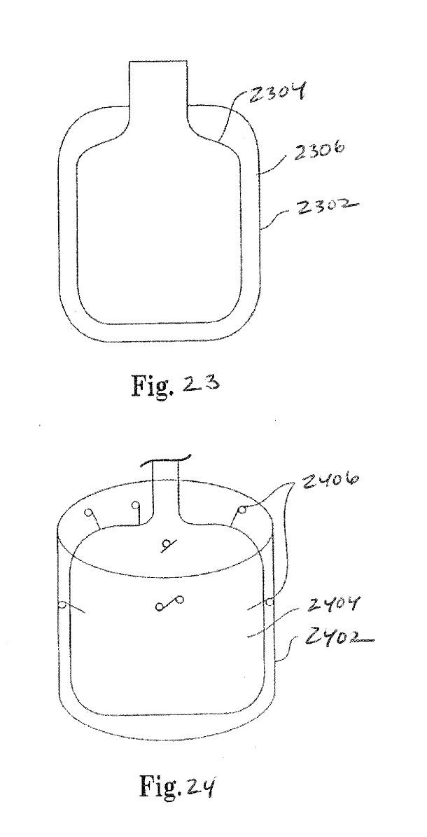

In another embodiment shown in FIG. 23, a liner 2304 may be placed within an overpack 2302 that is comprised of an elastic balloon-like material. A relatively small amount of a lubricating fluid 2306, for example water or saline or any other suitable liquid may be included between the overpack 2302 wall and the liner 2304 wall. Upon pump dispense, for instance, the elastic overpack walls may collapse substantially evenly thereby helping to minimize creases or folds forming in the liner.

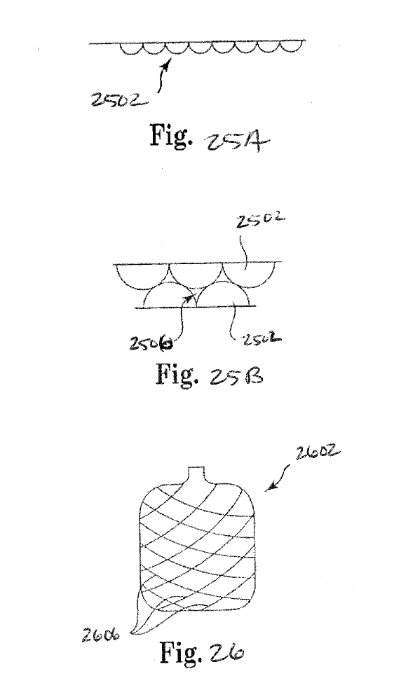

In another embodiment shown in FIG. 24, a liner 2404 may be suspended in an overpack 2402 by any suitable means, such as by hooks or any other connective means 2406. Anchoring the top of the liner 2404 in such a manner to the top of the overpack 2402 at a plurality of points may limit how much the sides of the liner can collapse. The liner may be suspended by any number of points including one, two, three, four or more points.

In another embodiment, the surface of the inside of the liner may be comprised of a textured surface 2502 as shown in FIGS. 25A and 25B. When the liner collapses, dispense channels 2506 may form between the textured surfaces 2502 of the liner such that liquid may still be able to flow through areas where the sides of the liner may have collapsed upon itself, thus increasing dispensability.

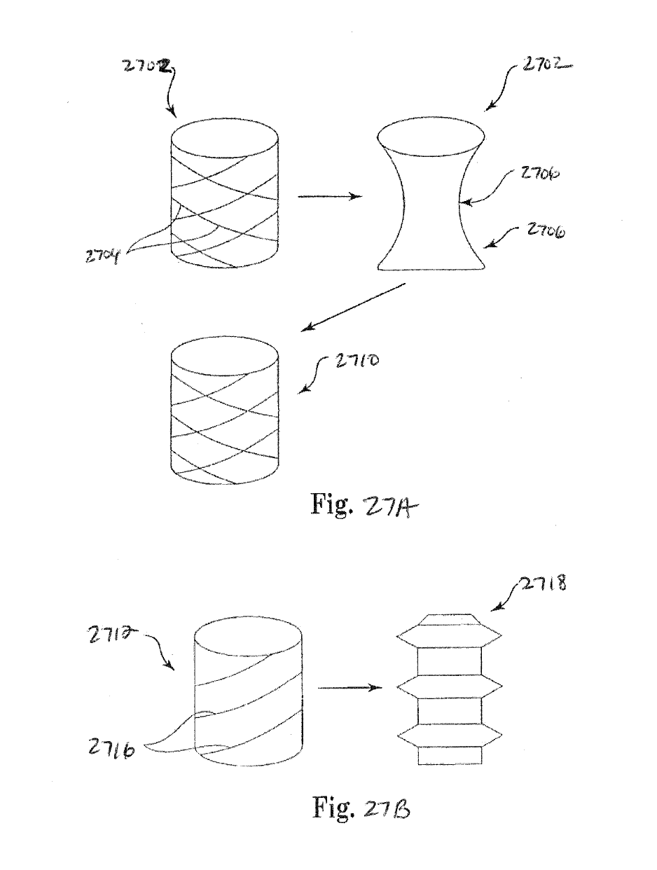

In still another embodiment, as shown in FIG. 26, a liner 2602 may comprise a number of folds formed in a criss-crossing-like manner such that when the liquid contents of the liner are dispensed, the liner may twist along the folds, thus increasing dispensability. The number of folds may be any appropriate number.

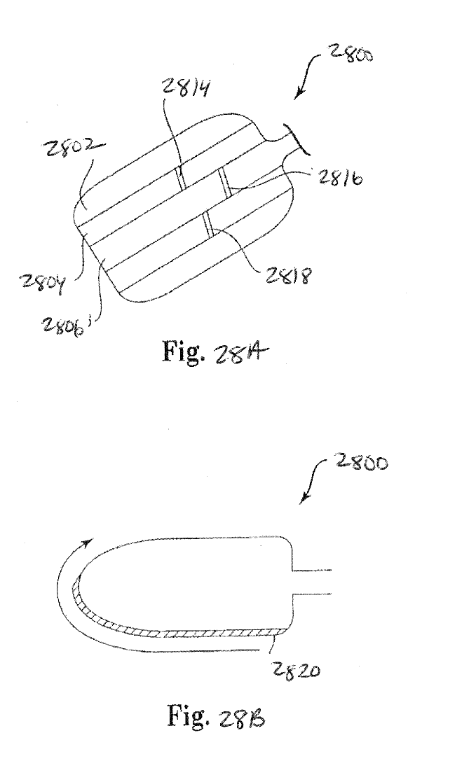

In another embodiment, as shown in FIGS. 27A and 27B, a liner 2702 may include an external elastomeric mesh 2704 that may help to adjust the collapse points of the liner 2702 upon dispense. As may be seen in FIG. 27A, in one embodiment, when the liner is subjected to either pump or pressure dispense, the force of the elastomeric mesh 2704 on the liner 2702 may collapse the liner 2702 inward at different points 2706 due to the pressure applied by the dispensing action. The portions that are briefly pulled inward 2706 may cause the non-inward moving parts 2708 of the liner to stretch more. The liner 2702 will naturally become balanced again 2710 by the stretched parts of the liner returning to their relaxed state 2710. Such movement of the liner 2702 upon dispense may help the contents of the liner 2702 to be dispensed more quickly and/or more completely. FIG. 27B shows another embodiment of a liner 2712 using elastomeric mesh 2716, whereupon when pressure is applied during dispense, the liner 2712 may deform 2718 in a substantially uniform manner.

In yet another embodiment, a shape memory polymer may be used to direct liner collapse upon dispense to help prevent choke-off, as may be seen in FIGS. 28A and 28B. For example, a shape memory polymer may be used as at least one side of the liner 2800 or attached to at least one side of the liner. The memory shape may be applied to the liner, for example, in strips 2802, 2804, 2806, in some embodiments. The strips 2802, 2804, 2806 may be kept separated by, for example, rigid spacers 2814, 2816, 2818. The shape memory polymer 2820 may cause the liner 2800 to coil up upon dispense, as shown in FIG. 28B, much like a party whistle curls up when a user blows air into it.

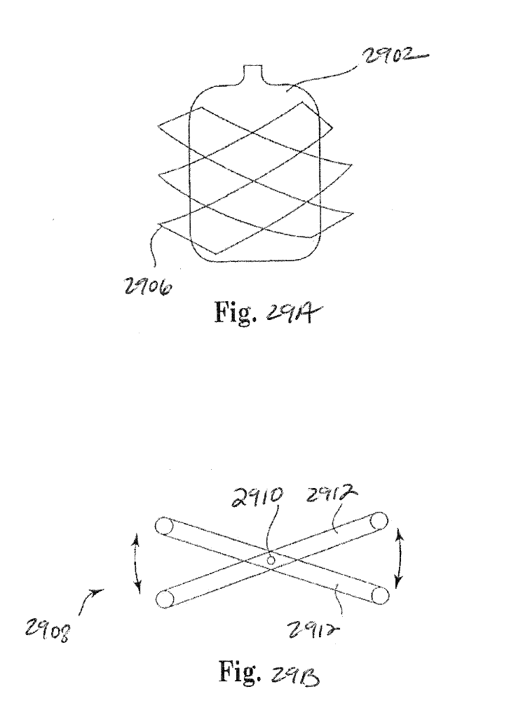

In another embodiment, shown in FIG. 29A, an external framework, similar to a hoberman sphere, may be used to control the shape of the liner upon dispense in order to, for example, help prevent choke-off. A hoberman sphere is capable of folding down to a fraction of its normal size by the scissor-like action of its joints. Such a framework 2906 may help the liner 2902 collapse in a pre-determined way that avoids choke-off As may be seen in FIG. 29B, each lattice 2908 of the framework 2906 may comprise a pivot 2910 that allows the arms 2912 of the lattice 2908 to move closer or further away from one another. In a framework 2906, the lattices may all work together, similar to a hoberman sphere to direct collapse during dispense. In some embodiments a flexible tether may also be used.

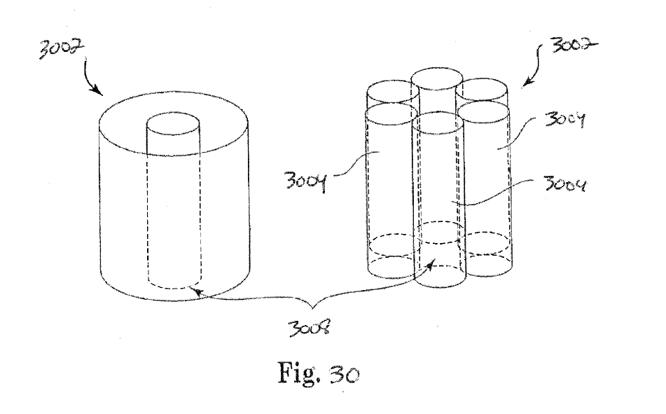

FIG. 30 shows another embodiment of a liner 3002 that may help limit or eliminate choke-off As may be seen, the liner 3002 may comprise a plurality of interconnected tubes. The tubes 3004 may be connected in such a manner as to allow the contents of the liner to flow freely between the tubes 3004. The inner wall of the liner 3002, in some embodiments, may be comprised of an elastomer that may inflate during dispense. As shown, the center of the liner 3002 may be hollow. In some embodiments, the pressure applied to the liner 3002 during dispense may prevent the center hollow tube 3002 from deformation and thus help stabilize the liner 3002 from collapse and choke-off.

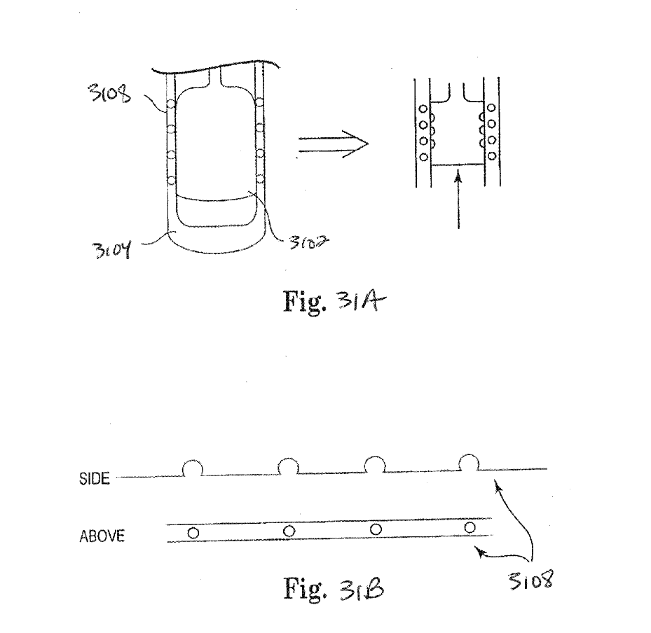

In another embodiment, shown in FIGS. 31A and 31B, slide point rails 3108 may be used to secure portions of the side of a liner 3102 to an overpack 3104, thereby keeping the liner 3102 from collapsing in upon itself during dispense. FIG. 31B shows a view of the slide point rails from the side and from above. The liner 3102 may have nubs that fit into channels in the rails 3108 of the overpack 3104. As the contents of the liner are dispensed the liner 3102 may be pushed upward, but the walls of the liner 3102 may stay attached to the walls of the overpack 3104.

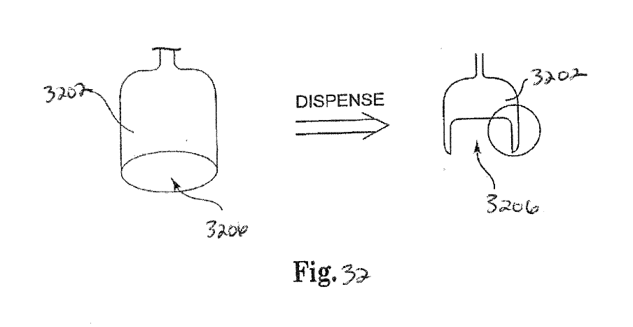

As may be seen in FIG. 32, another embodiment for helping to limit or eliminate choke-off may include an integrated piston. In such an embodiment, a liner 3202 may include a bottom 3206 that may be more rigid than the sides of the liner.

Accordingly, upon dispense the liner walls may be prevented from collapsing toward one another because the rigidity of the bottom 3206 of the liner 3202 may act as a piston keeping the walls apart.

Although the present invention has been described with reference to preferred embodiments, persons skilled in the art will recognize that changes may be made in form and detail without departing from the spirit and scope of the invention.

We claim:

1. A liner comprising:
a tubular body portion having a top circumferential edge and a bottom circumferential edge;
a generally circular bottom portion sealed to the tubular body portion along the bottom circumferential edge; and
a generally circular top portion sealed to the tubular body portion along the top circumferential edge and including a fitment sealed thereto.

2. The liner of claim 1, wherein the tubular body portion comprises at least one weld seam extending from the top circumferential edge to the bottom circumferential edge.

3. The liner of claim 2, wherein the tubular body portion comprises two sheets welded together to form a tubular body, the tubular body portion thus having two weld seams extending from the top circumferential edge to the bottom circumferential edge.

4. The liner of claim 1, wherein the liner is configured to be positioned within a non-removable head container having no larger than a three inch opening by inserting the liner in a collapsed state into the container through the opening, with the fitment positioned adjacent the opening.

5. The liner of claim 4, wherein each of the liner portions comprises a liner wall having multiple layers.

6. The liner of claim 5, wherein the thickness of the liner walls is from 80 microns to 280 microns.

7. The liner of claim 1, further comprising means for reducing the occurrence of a choke point.

8. A liner-based system comprising:
an overpack comprising a generally cylindrically-shaped interior and having an opening on at least one end; and
a flexible liner positioned within the overpack and comprising:
a tubular body portion having a top circumferential edge and a bottom circumferential edge;
a generally circular bottom portion sealed to the tubular body portion along the bottom circumferential edge; and
a generally circular top portion sealed to the tubular body portion along the top circumferential edge and including a fitment sealed thereto.

9. The liner-based system of claim 8, wherein the overpack is a non-removable head container having no larger than a three inch opening.

10. The liner-based system of claim 8, wherein the liner, in an expanded state, substantially conforms to the generally cylindrically-shaped interior of the overpack.

11. The liner-based system of claim 10, wherein the tubular body portion comprises at least one weld seam extending from the top circumferential edge to the bottom circumferential edge.

12. The liner-based system of claim 11, wherein the tubular body portion comprises two sheets welded together to form a tubular body, the tubular body portion thus having two weld seams extending from the top circumferential edge to the bottom circumferential edge.

13. The liner of claim 11, wherein each of the liner portions comprises a liner wall having multiple layers.

14. The liner of claim 13, wherein the thickness of the liner walls is from 80 microns to 280 microns.

15. The liner-based system of claim 8, wherein the liner, in an expanded state, is configured for reduced stress to the top circumferential seal.

16. The liner-based system of claim 10, the overpack further comprising a fluid inlet in communication with an annular space between the overpack and the liner, permitting a gas or fluid to be introduced into the annular space, causing collapse of the liner and dispense of contents therein through the fitment.

17. A method for dispensing contents from a liner-based system, the method comprising:
coupling a pressure source to a fluid inlet of an overpack, the overpack comprising:
a generally cylindrically-shaped interior and having an opening on at least one end; and
a flexible liner positioned within the interior and comprising:
a tubular body portion having a top circumferential edge and a bottom circumferential edge;
a generally circular bottom portion sealed to the tubular body portion along the bottom circumferential edge; and
a generally circular top portion sealed to the tubular body portion along the top circumferential edge and including a fitment sealed thereto;
wherein the fluid inlet is in communication with an annular space between the overpack and the liner; and
dispensing contents of the liner by introducing a gas or fluid from the pressure source into the annular space via the fluid inlet, thereby collapsing the liner and causing dispense of contents therein through the fitment.

18. The method of claim 17, further comprising connecting a dispense connector to the fitment of the liner for receiving the dispensed contents, the dispense connector having a probe comprising a tube extending only a relatively short distance into an interior of the liner through the fitment.

19. The method of claim 18, further comprising removing headspace gas prior to dispensing contents of the liner.

20. The method of claim 18, further comprising monitoring a dispense pressure to determine when the liner nears empty.

21. The method of claim 17, wherein the tubular body portion comprises at least one weld seam extending from the top circumferential edge to the bottom circumferential edge.
